(19) United States
(12) Patent Application Publication
(10) Pub. No.: US 2019/0319270 A1
(43) Pub. Date: Oct. 17, 2019

(54) STRUCTURAL CERAMIC METAL-ION BATTERIES

(71) Applicant: MASSACHUSETTS INSTITUTE OF TECHNOLOGY, Cambridge, MA (US)

(72) Inventors: Angela Belcher, Lexington, MA (US); Alan Patrick Adams Ransil, Waltham, MA (US)

(73) Assignee: MASSACHUSETTS INSTITUTE OF TECHNOLOGY, Cambridge, MA (US)

(21) Appl. No.: 16/382,161

(22) Filed: Apr. 11, 2019

Related U.S. Application Data
(60) Provisional application No. 62/656,952, filed on Apr. 12, 2018.

(51) Int. Cl. H01M 4/62; H01M 10/0525; H01M 10/058

(52) U.S. Cl. CPC H01M 4/622; H01M 4/625; H01M 2220/30; H01M 10/058; H01M 2220/20; H01M 10/0525

(57) ABSTRACT

A battery can include a porous anode having an anode surface, a cathode having a cathode surface, and a separator between the porous anode and the cathode and having a separator surface, wherein each of the anode surface, the cathode surface and the separator surface include a binder including an inorganic material, wherein the binder adheres the porous anode, the cathode and the separator together.

### CLAIM OF PRIORITY

This application claims priority to U.S. Provisional Patent Application No. 62/656,952, filed Apr. 12, 2018, which is incorporated by reference in its entirety.

### TECHNICAL FIELD

This invention relates to structural batteries.

### BACKGROUND

The energy density of batteries has increased steadily since lithium ion batteries (LIBs) were commercialized in 1991. However, intercalation batteries are likely to reach the physical limits of their energy density in the next decades. This provides an incentive to develop novel methods for increasing the amount of battery material that can be incorporated into a device.

### SUMMARY

A battery can include a porous anode having an anode surface, a cathode having a cathode surface, and a separator between the porous anode and the cathode and having a separator surface, wherein each of the anode surface, the cathode surface and the separator surface include a binder including an inorganic material, wherein the binder adheres the porous anode, the cathode and the separator together.

In certain embodiments, the inorganic material can include a silicate, a phosphate, a borate, an aluminate, a sulfate, a nitride, or a combination thereof.

In certain embodiments, the binder can include a soluble sodium silicate.

In certain embodiments, the battery can be a component of a device, a vehicle or a handheld device.

In certain embodiments, the battery can further include an electrolyte.

In certain embodiments, the electrolyte can be in a liquid, a gel or a solid form.

In certain embodiments, the binder can function as an electrolyte.

In certain embodiments, the battery can further include a filler in the separator.

In certain embodiments, the filler can include silica powder or glass fiber.

In certain embodiments, the battery can be flexible.

A method of producing a battery can include casting an anode layer on a first substrate, casting a cathode layer on a second substrate, laminating the anode layer and the cathode layer on either side of a separator layer using a binder including an inorganic material, and annealing the anode layer, cathode layer and the separator layer.

In certain embodiments, the method can further include casting an anode layer from water-based slurries.

In certain embodiments, the method can further include casting an cathode layer from water-based slurries.

In certain embodiments, the annealing can be carried out between 300° C. and 600° C.

In certain embodiments, the binder can be wholly or partially removed during annealing.

In certain embodiments, the substrate can be wholly or partially removed during annealing.

In certain embodiments, the binder can include an inorganic polymer.

In certain embodiments, the inorganic polymer can include a silicate, a phosphate, a borate, an aluminate, a sulfate, a nitride, or a combination thereof.

In certain embodiments, the binder can include a soluble sodium silicate.

In certain embodiments, the binder can be applied as a polymer.

In certain embodiments, the polymer can be silicate glass.

In certain embodiments, the binder can be applied as a monomer.

In certain embodiments, the monomer can include a phosphate.

In certain embodiments, the binder can be applied as a precursor.

In certain embodiments, the precursor can be tetraethyl orthosilicate (TEOS) or methyl orthosilicate (MEOS).

In certain embodiments, the method can further include adding an ion blocking layer.

In certain embodiments, the method can further include adding a current collector layer.

In certain embodiments, the method can further include adding an additive.

In certain embodiments, the additive can be an electrolyte precursor.

In certain embodiments, the additive can be an organic material.

In certain embodiments, the method can further include heat treatment.

In certain embodiments, the method can further include applying a packaging material.

In certain embodiments, the packaging material can include a carbon layer.

In certain embodiments, the packaging material can include a glass fiber or carbon fiber layer.

In certain embodiments, the method can further include adding an electrolyte.

Other aspects, embodiments, and features will be apparent from the following description, the drawings, and the claims.

### BRIEF DESCRIPTION OF THE DRAWINGS

FIG. 1 shows progressive reduction in the energy density of the energy-storing components of a Tesla model S. Battery active materials refer to the NCA/graphite redox couple used in the battery. Battery Cell is based on Panasonic 18650. Battery pack is based on an 85 kWh Tesla Model S pack. Model S vehicle is based on the energy in the 85 kWh pack divided by total vehicle mass. Each packaging step introduces more ‘inactive’ material which is not involved in energy storage. Using a Bulk Heterojunction Battery, structural battery materials may replace some of the inactive components and increase the overall vehicle energy density.

FIG. 2 shows a Structural Ceramic Battery (SCB) design. In this design, the novel silicate binder distributes load both within electrodes and across interfaces between adjacent layers. This is in contrast to typical electrode designs, in which adjacent layers are not adhered and in which binders are typically nonrigid.

FIG. 3 shows a SCB manufacturing process for flat samples. (a, b) The two electrodes are fabricated using silicate binder on a current collector substrate. C) silicate-based paste with added polymer and silica powder is used to bind the two electrodes together. Glass fiber can be added during this step as a separator material that also improves structural performance. D) the final electrode after heat treatment.

FIG. 4A shows a flexible electrode sheet incorporating temporary binder, before sintering. FIG. 4B shows a SCB manufacturing process using a temporary binder designed to improve flexibility of the pre-sintered electrode. The layup is similar to that depicted in FIG. 3, except that freestanding flexible electrodes are used and can be shaped using a mold.

FIG. 5 shows in-situ X-Ray Diffractogram of an LFP/silicate electrode. Electrode was heated under argon. Major impurity phases are not observed, indicating that the electrode is chemically stable and the silicate binder is compatible with the active material.

FIGS. 6A-6C show TEM analysis of a s-LFP electrode shows silicon (magenta) localized at the interface between carbon and LFP, acting as an effective binder for the electrode. FIG. 6A shows TEM image of an LFP particle surface. FIG. 6B shows STEM-EDX mapping. FIG. 6C shows overlay of STEM-EDX onto the TEM image shows silicon localized at the carbon/LFP interface. Impurity phases were not observed, confirming the conclusions from XRD that the silicate and LFP are compatible.

FIGS. 7A-7C show results from LFP optimization and cycling. FIG. 7A shows heat treatment tests show that the silicate achieves optimal rate capability when heated to 500° C. This is likely due to improved ionic conductivity resulting from annealing. FIG. 7B shows a comparison between the rate capability of LFP electrodes made using the silicate binder and a typical PVDF binder. The silicate shows improved rate capability, likely due to favorable interactions between the ionic silicate binder and lithium ions. Active loading was 1.6 mg/cm2 for silicate and 1.07 mg/cm\hat{ }2 for the PVDF samples. FIG. 7C shows long-term cycling tests show that the LFP/silicate electrode is extremely stable. This test was conducted at a 2C charge and discharge rate based on nominal capacity, following 3 forming cycles at C/20.

FIG. 8A shows long-term cycling data for graphite-silicate electrodes at C/5. No capacity degradation is observed after more than 350 cycles. FIG. 8B shows a full SCB undergoing testing. The SCB has been packaged in a polypropylene bag, but subsequent versions may use carbon fiber as an alternative. FIG. 8C shows discharge of an LFP/graphite SCB. The SCB exhibits an energy density of 85 Wh/Kg on an active materials basis, and 252 mAh/g based on the limiting graphite electrode. This discharge was conducted at the C/20 rate.

FIG. 9 shows mechanical properties of silicate films treated at 500° C. vs. PVDF films. Silicate is a stiff material that does not soften when exposed to electrolyte, unlike PVDF which has a Young's modulus two orders of magnitude lower and softens considerably in electrolyte. See, Kovalenko, I., et al. (2011). A major constituent of brown algae for use in high-capacity Li-ion batteries. Science, 334(6052), 75-79, which is incorporated by reference in its entirety.

FIGS. 10A-10D show fracture toughness can be varied by adjusting the amount of silicate in an LFP electrode. FIG. 10A shows a profile of one electrode tested, confirming the thickness of the sample. FIG. 10B shows as silicate content is increased, K_{Ic} shows a minimum at an intermediate value. Increased silicate ultimately results in higher K_{Ic} for high silicate loading. FIG. 10C shows trends in fracture toughness at constant silicate content. Increasing the conductive carbon content decreases fracture toughness, as expected. Increasing the amount of silicate and carbon together increases the fracture toughness, indicating that increased silicate outweighs the effect of increased carbon. FIG. 10D shows when the mass fractions of Super-P and silicate are equal, increasing the amount of binder monotonically increases K_{IC}.

FIGS. 11A-11C show two papers use SiO₂-based sol-gel binders for lithium intercalation batteries, from D Aurbach, MD Levi, O Lev, J Gun, and L Rabinovich. Behavior of lithiated graphite electrodes comprising silica based binder, Journal of applied electrochem-istry, 28(10):1051-1059, 1998, and Leonid Rabinovich, Jenny Gun, Ovadia Lev, Doron Aurbach, Boris Markovsky, and Michael D. Levi. Sol-gel-derived carbon ceramic electrodes: A new lithium intercalation anode, Advanced Materials, 10(8):577-580, 1998, each of which is incorporated by reference in its entirety. FIG. 11A shows the cycling data for these electrodes is worse than comparable data for conventional PVDF-based electrodes. FIGS. 11B-11C show formation of SEI on the graphite surface in carbon ceramic electrodes. The pristine electrode (FIG. 11A) is covered by a thick insulating layer after one electrochemical cycle in an ethylene carbonate/dimethyl carbonate electrolyte.

FIGS. 12A-12B show voltage curves showing the effect of heat treatment on electrode performance. FIG. 12A shows s-LFP half cells charged at C/10 and discharged as shown at C/10. FIG. 12B shows s-Graphite half cells lithiated at C/10 and delithiated as shown at 2C. Both datasets correspond to discharge of a full cell.

FIGS. 13A-13B show representative voltage curves showing the effect of electrode composition on s-LFP rate capability. Examples of low (FIG. 13A) and high (FIG. 13B) binder content are demonstrated, in which the binder content equals the Super P conductive carbon content.

FIGS. 14A-14B show discharge capacities of s-LFP half cells at 5C rate. FIG. 14A shows silicate has a strong effect on rate capability, with 10 wt % silicate exhibiting a relatively low capacity at 5C. FIG. 14B shows Super P has very little effect on rate capability under these conditions. The trend line shown in FIG. 14A is for the dataset as a whole, and is labeled with its slope m in units of mAh/g/m %.

FIGS. 15A-15B show TEM investigation of the active LFP surface. FIG. 15A shows s-LFP electrode as-deposited, without heat treatment. FIG. 15B shows s-LFP electrode following 500° C. heat treatment. Both show crystalline active material with a graphitic coating.

FIGS. 16A-16B show elemental mapping of s-LFP electrodes. FIG. 16A shows an electrode with no heat treatment. FIG. 16B shows an electrode treated at 500° C. Both electrodes show localization of silicate primarily in the conductive carbon rather than on the active surface.

FIG. 17 shows polymers used to reinforce electrodes in order to facilitate the SCB fabrication process.

FIG. 18 shows the chemistry of binders used, and the mechanical properties of CMC with plasticizer. FIG. 18 panel (a) shows sodium trisilicate, the permanent binder used in this system.

FIG. 18 panel (b) shows sodium carboxymethyl cellulose, the temporary organic binder used to prevent thick films from cracking during drying. FIG. 18 panel (c) shows glycerol, the small molecule added as a plasticizer to CMC in order to make mechanically flexible electrode sheets. FIG. 18 panel (d) shows mechanical properties of various CMC film compositions, showing that the addition of glycerol can substantially increase the elasticity of these films.

FIGS. 19A-19B show electrodes made using carbon nanofiber (CNF) reinforcement. FIG. 19A shows graphite electrode made using MCMBs. FIG. 19B shows LFP electrode. CNFs are visible in both images (see arrows).

FIG. 20 shows effect of separator paste composition on morphology. The sample at 10 wt % silicate exhibits the composition described in Table 5. This sample shows some aggregation of particles as highlighted by the arrows.

FIGS. 21A-21C show the separator composition was measured using electrochemical impedance spectroscopy (EIS). FIG. 21A show separator samples made as described herein were loaded into CR2023 coin cells in the configuration shown. FIG. 21B shows control and test samples were tested using EIS, and the high-frequency intercept with the real axis was taken to be RS. FIG. 21C shows R_{Eff} corresponding to ionic solution resistance through the sample was calculated and plotted as a function of separator composition.

FIGS. 22A-22C show a full SCB cell fabricated to fit inside a coin cell casing. FIG. 22A shows the design of this SCB, prefabricated as a freestanding SCB from electrode and separator sheets. FIG. 22B shows one discharge of this cell and the subsequent charge, normalized by graphite mass. Charge and discharge are both at C/20, with a trickle charge step. FIG. 22C shows several cycles of this cell.

FIG. 23 shows template for a dogbone tensile sample.

FIGS. 24A-24B show tensile tests of full SCB stacks with varied amounts of PEO additive. FIG. 24A shows a dogbone sample in the Zwick mechanical tester. FIG. 24B shows tensile test results.

FIGS. 25A-25B show that electrodes made with flexible sheets have adequate capacity.

FIG. 25A shows performance of graphite electrodes. FIG. 25B shows performance of LFP electrodes.

FIGS. 26A-B show that a lithium trisilicate binder may be used in SCB electrodes. FIG. 25A compares discharge curves of electrodes made using sodium trisilicate and lithium trisilicate as binders, in which the electrodes are similar in all other respects and a high binder content is used. 25B compares cycling data for the same two electrodes.

### DETAILED DESCRIPTION

Disclosed herein is a battery in which electrode layers and separator layers all contain an binder including an inorganic material, and external loads are distributed both between and within electrode and separator layers. In certain embodiments, the battery can be used as a component of a device, such as a vehicle or handheld device, and it is designed as a load-bearing element of the device. The binder can be a crystalline solid, noncrystalline solid or a polymer. The inorganic material can comprise a silicate, phosphate, borate, aluminate, sulfate, nitride, mixtures or copolymers of these. In certain embodiments, the binder can include Na₄SiO₄, Na₂SiO₃, Na₂Si₃O₄, Li₄SiO₄, Li₂SiO₃, Li₂Si₃O₄, Li₂PO₂N, Li_{z}POₓN_{y} (where z is 1 to 3, x is 1 to 4, and y is 0 to 2, preferably integers), Li₂B₄O₇, LiAlO₂, LiN, and Li₆PS₅Cl.

In certain embodiments, the battery can contain a liquid, gel or solid electrolyte in addition to the binder, the binder may function as an electrolyte, or some combination of these may occur. In certain embodiments, the device can include a solid electrolyte inorganic binder reinforced with a gel polymer electrolyte in the pores.

A process for producing a load-bearing battery can include the following steps: (1) Sequential layers of battery material are laid down on a substrate. They may be applied as sheets, as slurries, as slurry-soaked sheets, or as combinations thereof. The substrate is designed to provide shape to the battery, for example forming it into a curved or flat surface according to the design requirements of a device, (2) Among these layers are electrode and separator layers that include an inorganic binder. The binder may be applied as a polymer (ex. silicate glass), a monomer (ex. phosphate) or a precursor (ex. tetraethyl orthosilicate (TEOS) or methyl orthosilicate (MEOS)) and may be pre-existing in the layers if they are applied as solid sheets, (3) May also include other layers such as ion blocking layers and/or current collector layers in order to remove current from the device, (4) May be one battery stack thick or multiple stacks, (5) The material is then cured through a heat treatment, (6) Additives such as electrolyte precursors or organic reinforcement may be infiltrated into the battery at this stage. This may include an additional heat treatment or similar processing steps, (7) Packaging material is then applied in order to protect the final battery. This may involve coating the material, such as by carbon or glass fiber layers, (8) A liquid electrolyte may be added and the packaging material sealed.

Battery research has historically focused on improving the properties of the active materials that directly store energy. Structural batteries are an alternative route to optimize device performance, aiming to replace structural materials such as metals, plastics, and carbon fiber with energy-storing materials. This strategy could more than double the battery lifetime of electronic devices without requiring breakthroughs in the active materials themselves. Rigid, load-bearing electrodes can be fabricated using a novel geopolymer silicate binder and that this binder can also be used to adhere adjacent battery layers in order to distribute load throughout the device. This innovation turns the entire battery stack into a monolithic engineering ceramic that is called a Structural Ceramic Battery (SCB). Unlike previously published binders, this material does not soften with the introduction of electrolyte, it promotes charge transport within the electrode, and it is compatible with a range of active materials employed in batteries today. Water soluble silicates are known to form strong ionic bonds with inorganic materials and this property has given rise to durable inorganic products. However, this material has never been used as a binder in intercalation electrodes. Additionally, as this innovation is a binder material and fabrication method for structural batteries, it can be used with multiple active materials. As new materials are discovered, it is envisioned that they can be dropped in to the SCB architecture. This will allow SCBs to maintain a performance edge over other battery designs.

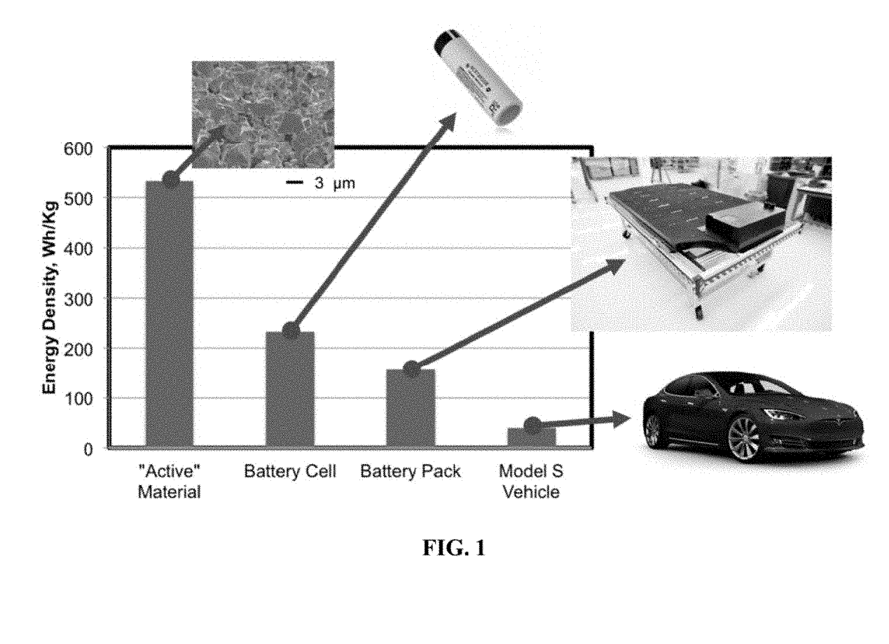

Improving vehicle-level energy density is key for enabling electric passenger aviation. While battery research has historically focused on increasing energy density at the active materials level, there has been rising interest in multifunctional systems aiming to replace load-bearing vehicle components with structural energy storage materials. See Ferreira, Andre Duarte B L, Paulo R O Novoa, and Antonio Torres Marques. “Multifunctional material systems: a state-of-the-art review.” Composite Structures 151 (2016): 3-35, Zhang, Yancheng, et al. “Multifunctional structural lithium-ion battery for electric vehicles.” Journal of Intelligent Material Systems and Structures 28.12 (2017): 1603-1613, Hudak, Nicholas S., Alexander D. Schlichting, and Kurt Eisenbeiser. “Structural Supercapacitors with Enhanced Performance Using Carbon Nanotubes and Polyaniline.” Journal of The Electrochemical Society 164.4 (2017): A691-A700, and Shirshova, N., Qian, H., Shaffer, M. S., Steinke, J. H., Greenhalgh, E. S., Curtis, P. T., . . . & Bismarck, A. (2013). Structural composite supercapacitors. Composites Part A: Applied Science and Manufacturing, 46, 96-107, each of which is incorporated by reference in its entirety. This strategy could increase the endurance of aerial vehicles by 200% using existing active material chemistries. See Schlichting, Alex, and Kurt Eisenbeiser. “Multifunctional Power Systems for Improved Size, Weight, and Power (SWaP) in Portable Electronic Systems.” (2015), which is incorporated by reference in its entirety. The scope for improvement in electric cars is illustrated in FIG. 1.

Strategies for structural energy storage have included transferring load to conventional lithium-ion batteries, employing current collectors as structural members, producing load-bearing electrodes as drop-in components of a standard battery layup, developing structural polymer-based binder materials, and using structural carbon fiber electrodes to bear load. See Wang, Y., Peng, C., & Zhang, W. (2014). Mechanical and electrical behavior of a novel satellite multifunctional structural battery, Wang, Meng, et al. “A multifunctional battery module design for electric vehicle.” Journal of Modern Transportation 25.4 (2017): 218-222, Ma, Jun, Christopher Rahn, and Mary Frecker. “Optimal Battery-Structure Composites for Electric Vehicles.” ASME 2016 10th International Conference on Energy Sustainability collocated with the ASME 2016 Power Conference and the ASME 2016 14th International Conference on Fuel Cell Science, Engineering and Technology. American Society of Mechanical Engineers, 2016, Evanoff, Kara, et al. “Ultra strong silicon-coated carbon nanotube nonwoven fabric as a multifunctional lithium-ion battery anode.” ACS nano 6.11 (2012): 9837-9845, Shirshova, N., Bismarck, A., Carreyette, S., Fontana, Q. P., Greenhalgh, E. S., Jacobsson, P., . . . & Scheers, J. (2013). Structural supercapacitor electrolytes based on bicontinuous ionic liquid-epoxy resin systems. Journal of Materials Chemistry A, 1(48), 15300-15309, Snyder, J. F., Wong, E. L., & Hubbard, C. W. (2009). Evaluation of commercially available carbon fibers, fabrics, and papers for potential use in multifunctional energy storage applications. Journal of the Electrochemical Society, 156(3), A215-A224, Kim, Hyon C., and Ann M. Sastry. “Effects of carbon fiber electrode deformation in multifunctional structural lithium ion batteries.” Journal of Intelligent Material Systems and Structures 23.16 (2012): 1787-1797, Leijonmarck, Simon, et al. “Solid polymer electrolyte-coated carbon fibres for structural and novel micro batteries.” Composites Science and Technology 89 (2013): 149-157, and Ekstedt, S., Wysocki, M., & Asp, L. E. (2010). Structural batteries made from fibre reinforced composites. Plastics, rubber and composites, 39(3-5), 148-150, each of which is incorporated by reference in its entirety. To maximize structural efficiency, a structural battery should transfer load to active electrodes as well as between adjacent battery layers. An optimal design would also be compatible with a range of active materials and standard organic electrolytes.

Disclosed herein is a water soluble silicate used as a binder fulfilling these requirements, resulting in a robust Structural Ceramic Battery (SCB). In certain embodiments, the water soluble silicate can be sodium trisilicate. Silicates are an abundant class of minerals comprising the majority of the earth's crust. Because of their propensity to form durable ionic bonds they are used as a binder in mineral paint, as adhesives for paper and ceramics, as pottery glazing, and as a sealant for cement. Many of the resulting silicate-based products are extremely durable, withstanding more than one hundred years of exposure to exterior environmental conditions and heat treatments up to 2000° C. See Keim, Inc. “Colour Stability.” (Online) Available: https://www.keim.com/en-gb/keim-library/colour-stability/. Accessed Feb. 6, 2018, and Pelco, Inc. “Pelco High Temperature Carbon Paste, 50 g Product No. 16057” (Online) Available: https://www.tedpella.com/technote_html/16057%20TN.pdf. Accessed Accessed Feb. 6 2018, each of which is incorporated by reference in its entirety. In addition, silicates of varied stoichiometry have been shown to be lithium conductive and have been used as thin film solid electrolytes. See Furusawa, S. I., Kasahara, T., & Kamiyama, A. (2009). Fabrication and ionic conductivity of Li2SiO3 thin film. Solid State Ionics, 180(6-8), 649-653, Sakuda, A., Kitaura, H., Hayashi, A., Tadanaga, K., & Tatsumisago, M. (2008). Improvement of high-rate performance of all-solid-state lithium secondary batteries using LiCoO2 coated with Li2O—SiO2 glasses. Electrochemical and Solid-State Letters, 11(1), A1-A3, Furusawa, S. I., Kamiyama, A., & Tsurui, T. (2008). Fabrication and ionic conductivity of amorphous lithium meta-silicate thin film. Solid State Ionics, 179(15-16), 536-542, Ariel, N., Ceder, G., Sadoway, D. R., & Fitzgerald, E. A. (2005). Electrochemically controlled transport of lithium through ultrathin Si O 2. Journal of applied physics, 98(2), 023516, and Nakagawa, A., Kuwata, N., Matsuda, Y., & Kawamura, J. (2010). Characterization of stable solid electrolyte lithium silicate for thin film lithium battery. Journal of the Physical Society of Japan, 79(Suppl. A), 98-101, each of which is incorporated by reference in its entirety. This combination of binder properties allows us to circumvent drawbacks of other structural battery designs by employing rigid electrodes as load-bearing members, providing a bond between adjacent electrode and separator layers, allowing the use of diverse active materials and electrolytes, and promoting ion transport while transferring load.

One example exists in the literature of a similar silica/graphite composite cycled electrochemically as an intercalation electrode. See Oskam, G., & Searson, P. C. (1998). Sol-Gel Synthesis and Characterization of Carbon/Ceramic Composite Electrodes. The Journal of Physical Chemistry B, 102(14), 2464-2468. D Aurbach, MD Levi, 0 Lev, J Gun, and L Rabinovich. Behavior of lithiated graphite electrodes comprising silica based binder. Journal of applied electrochem-istry, 28(10):1051-1059, 1998. Leonid Rabinovich, Jenny Gun, Ovadia Lev, Doron Aurbach, Boris Markovsky, and Michael D. Levi. Sol-gel-derived carbon ceramic electrodes: A new lithium intercalation anode. Advanced Materials, 10(8):577-580, 1998. These are incorporated by reference in their entirety. It should be noted that these samples were made using a sol-gel process unlike the water-soluble silicate binder presented here. This process results in a chemically and morphologically distinct electrode, and forgoes the facile processing method. In addition, the previously published battery exhibited greater than a 35% capacity decrease over 40 cycles. By contrast, the s-MCMB electrode shows no capacity loss after >250 cycles. This suggests that the differences in processing method, morphology, and chemistry are substantive in that they affect performance.

In addition, geopolymer composites have been developed in academia and industry over the past fifty years for a variety of applications. See Davidovits, J. (2002, October). years of successes and failures in geopolymer applications. Market trends and potential breakthroughs. In Geopolymer 2002 Conference (Vol. 28, p. 29). Geopolymer Institute, Saint-Quentin France, Melbourne, Australia, Geopolymer Institute Website. Online. Available: https://www.geopolymer.org/Accessed Mar. 9, 2018, and Davidovits, J. (1991). Geopolymers: inorganic polymeric new materials. Journal of Thermal Analysis and calorimetry, 37(8), 1633-1656, each of which is incorporated by reference in its entirety. Geopolymers are primarily taken to be silicates, aluminates, and copolymers of these. These materials have been used as carbon fiber binders, concrete and fire retardant building materials, as binders in refractory materials, and in other applications. See Lin, T., Jia, D., He, P., Wang, M., & Liang, D. (2008). Effects of fiber length on mechanical properties and fracture behavior of short carbon fiber reinforced geopolymer matrix composites. Materials Science and Engineering: A, 497(1-2), 181-185, He, P., Jia, D., Lin, T., Wang, M., & Zhou, Y. (2010). Effects of high-temperature heat treatment on the mechanical properties of unidirectional carbon fiber reinforced geopolymer composites. Ceramics International, 36(4), 1447-1453, Lin, T., Jia, D., Wang, M., He, P., & Liang, D. (2009). Effects of fibre content on mechanical properties and fracture behaviour of short carbon fibre reinforced geopolymer matrix composites. Bulletin of Materials Science, 32(1), 77-81, Gourley, J. T., & Johnson, G. B. (2005). Developments in geopolymer precast concrete. In World Congress Geopolymer(pp. 139-143), Zhang, H. Y., Kodur, V., Qi, S. L., Cao, L., & Wu, B. (2014). Development of metakaolin-fly ash based geopolymers for fire resistance applications. Construction and Building Materials, 55, 38-45, Zhang, Z., Provis, J. L., Reid, A., & Wang, H. (2014). Geopolymer foam concrete: An emerging material for sustainable construction. Construction and Building Materials, 56, 113-127, Bernal, S. A., Bejarano, J., Garzón, C., De Gutierrez, R. M., Delvasto, S., & Rodriguez, E. D. (2012). Performance of refractory aluminosilicate particle/fiber-reinforced geopolymer composites. Composites Part B: Engineering, 43(4), 1919-1928, and Djangang, C. N., Tealdi, C., Cattaneo, A. S., Mustarelli, P., Kamseu, E., & Leonelli, C. (2015). Cold-setting refractory composites from cordierite and mullite-cordierite design with geopolymer paste as binder: Thermal behavior and phase evolution. Materials Chemistry and Physics, 154, 66-77, each of which is incorporated by reference in its entirety. They have not been previously used as binders in intercalation battery electrodes.

There is a body of literature covering the use of silica as a binder for carbon electrodes. These electrodes are chemically similar to SCB electrodes in that they use a silica-based binder. However, they are produced via sol-gel synthesis. Thus, the silica made from them is pure (rather than a soluble silicate), they require organosilicon precursors, and the deposition involves a complex set of chemical and morphological changes characteristic of sol-gels. At the same time, they will be briefly mentioned here because they provide the closest electrochemical analogue to SCBs in the existing literature.

Carbon ceramic electrodes were introduced in 1994 as an alternative to carbon paste electrodes employing an organic binder. See Michael Tsionsky, Genia Gun, Victor Glezer, and Ovadia Lev. Sol-gel-derived ceramic-carbon composite electrodes: introduction and scope of applications. Analytical Chemistry, 66(10):1747-1753, 1994, which is incorporated by reference in its entirety. They were shown to be highly stable compared to carbon paste electrodes and have been proven a remarkably versatile electrode design that can be chemically modified for numerous applications. See G Gun, M Tsionsky, and O Lev. Voltammetric studies of composite ceramic carbon working electrodes. Analytica chimica acta, 294(3):261-270, 1994, Gerko Oskam and Peter C Searson. Sol-gel synthesis and characterization of carbon/ceramic composite electrodes. The Journal of Physical Chemistry B, 102(14):2464 {2468, 1998, L Rabinovich and O Lev. Sol-gel derived composite ceramic carbon electrodes. Electroanalysis, 13(4):265-275, 2001, and Michael Tsionsky, Genia Gun, Victor Glezer, and Ovadia Lev. Sol-gel-derived ceramic-carbon composite electrodes: introduction and scope of applications. Analytical Chemistry, 66(10):1747-1753, 1994, each of which is incorporated by reference in its entirety. They have been used for ion detection, for sensing biomolecules, as a fuel cell electrode and for various other reactions of interest such as hydrogen evolution. See Zhiqin Ji and Ana R Guadalupe. Reusable doped sol-gel graphite electrodes for metal ions determination. Electroanalysis, 11(3):167-174, 1999, Lihong Shi, Xiaoqing Liu, Haijuan Li, and Guobao Xu. Electrochemiluminescent detection based on solid-phase extraction at tris (2, 2 ?-bipyridyl) ruthenium (ii)-modied ceramic carbon electrode. Analytical chemistry, 78(20):7330-7334, 2006, Peng Wang, Xiangping Wang, and Guoyi Zhu. Sol-gel-derived ceramic carbon composite electrode containing isopolymolybdic anions. Electrochimica acta, 46(5):637-641, 2001, H Razmi and H Heidari. Nafion/lead nitroprusside nanoparticles modified carbon ceramic electrode as a novel amperometric sensor for 1-cysteine. Analytical biochemistry, 388(1):15-22, 2009, Abdollah Salimi, Richard G Compton, and Rahman Hallaj. Glucose biosensor prepared by glucose oxidase encapsulated sol-gel and carbon-nanotube-modified basal plane pyrolytic graphite electrode. Analytical biochemistry, 333(1):49-56, 2004, Abdollah Salimi, Hussein MamKhezri, and Rahman Hallaj. Simultaneous determination of ascorbic acid, uric acid and neurotransmitters with a carbon ceramic electrode prepared by sol-gel technique. Talanta, 70(4):823-832, 2006, Biuck Habibi and Nasrin Delnavaz. Electrocatalytic oxidation of formic acid and formaldehyde on platinum nanoparticles decorated carbon-ceramic substrate. international journal of hydrogen energy, 35(17):8831-8840, 2010, Esmaeil Habibi and Habib Razmi. Glycerol electrooxidation on pd, pt and au nanoparticles supported on carbon ceramic electrode in alkaline media. International journal of hydrogen energy, 37(22):16800-16809, 2012, H Razmi, Es Habibi, and H Heidari. Electrocatalytic oxidation of methanol and ethanol at carbon ceramic electrode modified with platinum nanoparticles. Electrochimica Acta, 53(28):8178-8185, 2008, Abdolkarim Abbaspour and Ehsan Mirahmadi. Electrocatalytic hydrogen evolutionreaction on microwave assisted sol-gel-derived carbon ceramic electrodes modified with metalophthalocyanines. Journal of Electroanalytical Chemistry, 652(1-2):32-36, 2011, Abdolkarim Abbaspour and Fatemeh Norouz-Sarvestani. High electrocatalytic effect of au-pd alloy nanoparticles electrodeposited on microwave assisted sol-gel-derived carbon ceramic electrode for hydrogen evolution reaction. International Journal of Hydrogen Energy, 38(4):1883-1891, 2013, and Santhanam Ranganathan and E Bradley Easton. High performance ceramic carbon electrode-based anodes for use in the cu-cl thermochemical cycle for hydrogen production. International Journal of Hydrogen Energy, 35(3):1001-1007, 2010, each of which is incorporated by reference in its entirety.

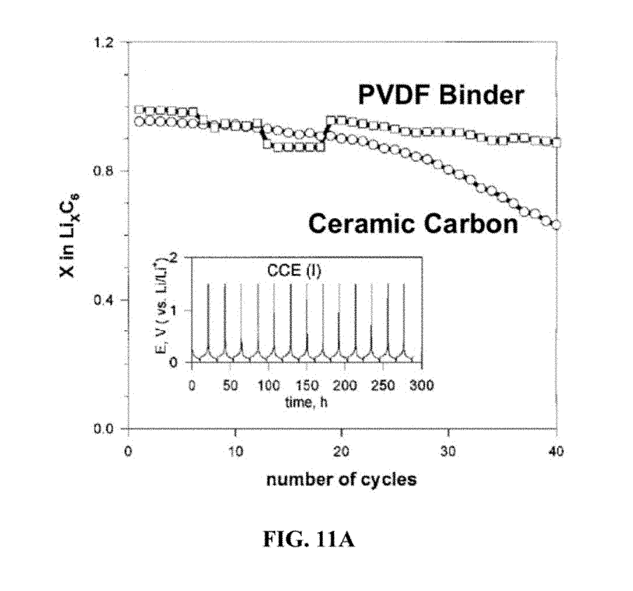

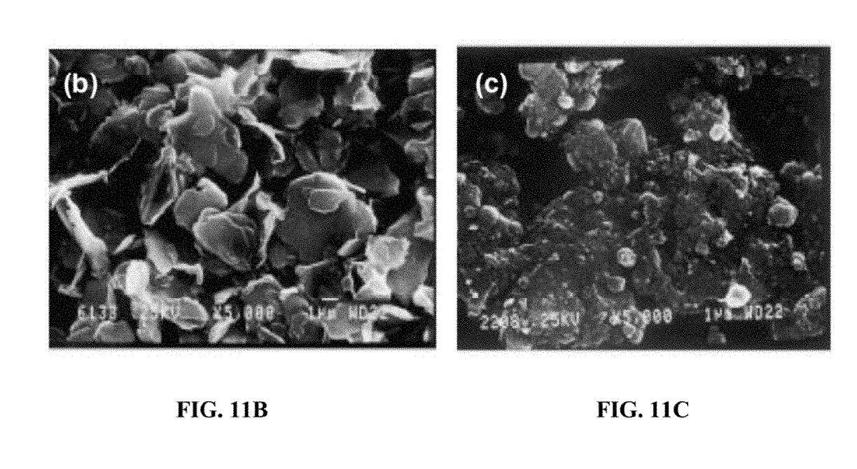

A carbon ceramic electrode was used as a lithium intercalation battery electrode both from the Aurbach group in the late 1990's. See D Aurbach, MD Levi, O Lev, J Gun, and L Rabinovich. Behavior of lithiated graphite electrodes comprising silica based binder. Journal of applied electrochemistry, 28(10):1051-1059, 1998, and Leonid Rabinovich, Jenny Gun, Ovadia Lev, Doron Aurbach, Boris Markovsky, and Michael D. Levi. Sol-gel-derived carbon ceramic electrodes: A new lithium intercalation anode. Advanced Materials, 10(8):577-580, 1998, each of which is incorporated by reference in its entirety. The electrochemical performance of these tests was not particularly promising (FIG. 11A), showing significantly worse cycling stability than PVDF-based graphite electrodes.

This was attributed to the formation of non-passivating SEI on the electrode surface, (FIGS. 11B-11C) more so than was observed in the PVDF-based electrodes. It was speculated that the SiO₂ binder morphology and interaction with graphite promotes the formation of this SEI. See D Aurbach, MD Levi, 0 Lev, J Gun, and L Rabinovich. Behavior of lithiated graphite electrodes comprising silica based binder. Journal of applied electrochemistry, 28(10):1051-1059, 1998, which is incorporated by reference in its entirety. Interestingly, much improved cycling stability was observed using a silicate-based binder. Extending the logic of Aurbach et al, is possible that the morphology of the sol-gel derived electrode does not effectively coat the graphite surface whereas the silicate does an improved job of passivation.

There are additionally a few examples of silicate being used as a binder in nonintercalation batteries. Sodium silicate was used as a binder in zinc air battery negative electrodes, resulting in improved electrode conductivity and higher conversion efficiency compared to electrodes made using polycarbonate binders. See Matthias Hilder, Bjorn Winther-Jensen, and Noel B Clark. The effect of binder and electrolyte on the performance of thin zinc-air battery. Electrochimica acta, 69:308-314, 2012, which is incorporated by reference in entirety. Silicates have been used as binders in thermal batteries. See Adolph Fischbach. Thermal batteries, Jun. 30, 1970. U.S. Pat. No. 3,518,125, which is incorporated by reference in its entirety. Lithium silicate is also cited as being used as a passivating layer on electrode surfaces resulting in reduced self-discharge for intercalation batteries, but no data was presented for this formulation. See Glenn G Amatucci and Jean-Marie Tarascon. Rechargeable battery cell having surface-treated lithiated intercalation positive electrode, Jan. 6, 1998. U.S. Pat. No. 5,705,291, which is incorporated by reference in its entirety.

### Fabrication and Characterization

Sodium silicate can be used as a mechanically robust adhesive for electrode components. In order to determine its use as a binder the electrochemical performance of composite electrodes were investigated. Silicate was employed to replace PVDF in electrodes based on aqueous slurries, and half cells were used to investigate performance as a function of composition and heat treatment. LiFePO₄ was chosen for the majority of these studies, as it is a well-studied and highly electrochemically reversible compound with a 3.5V voltage plateau within the electrochemical stability window of common organic electrolytes.

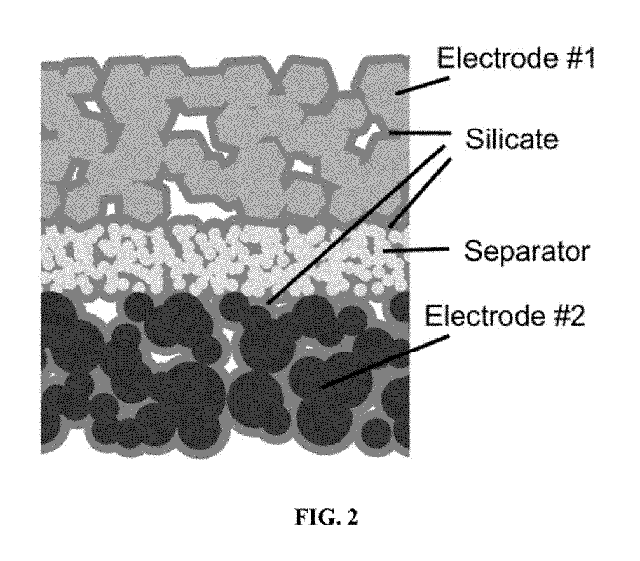

A SCB design is shown in FIG. 2. In this device, a rigid geopolymer binder is used to transfer load both within electrodes and across the electrode/separator interface. Silica powder or glass fiber is used as a filler in the separator layer. The entire SCB device functions as a rigid engineered ceramic composite, and due to the lack of organic polymers it can be annealed at temperatures in the 300-600° C. range to form strong ionic bonds.

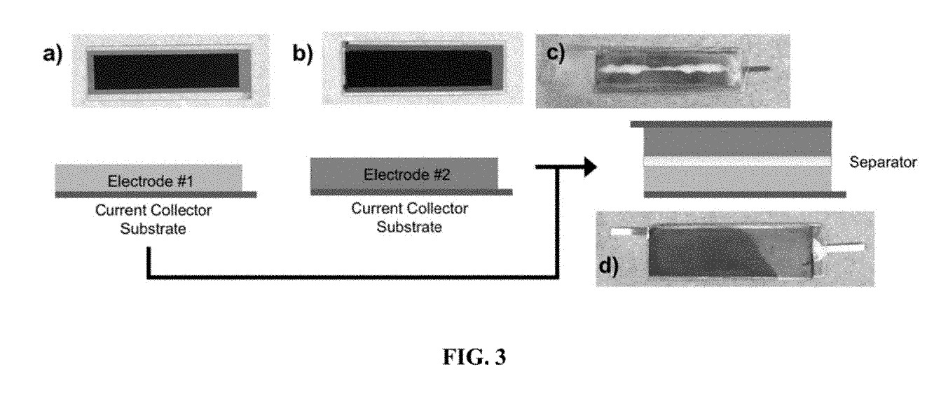

To demonstrate a scalable and environmentally friendly SCB manufacturing process is shown in FIG. 3. Anode and cathode layers were cast from water-based slurries onto substrates (FIGS. 3A and 3B). After drying, these electrodes were laminated on either side of a glass fiber separator using a silicate-based slurry as an adhesive (FIG. 3C). The entire stack was subsequently heat treated in order to cure the silicate and strengthen bonds both between and within electrode layers resulting in a structural ceramic battery (FIG. 3D).

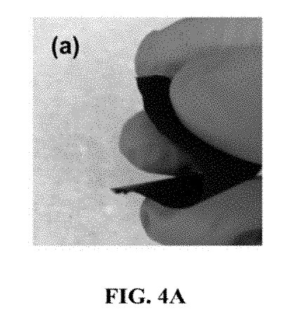

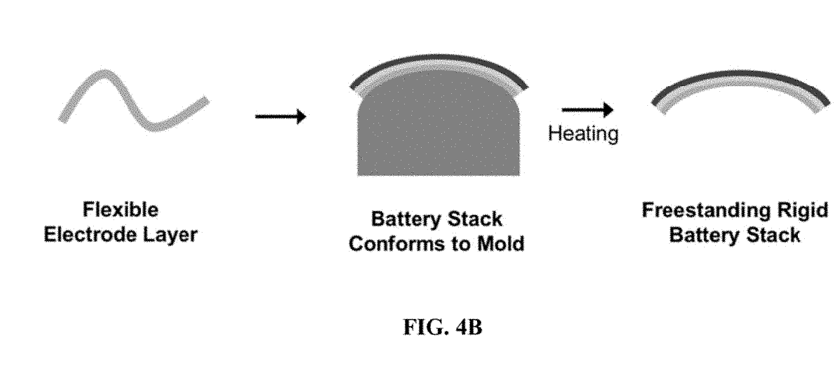

In addition, the electrodes can be fabricated using a temporary polymer binder that is wholly or partially removed during the sintering process (FIGS. 4A-4B). This allows the fabrication of freestanding (substrate-free) electrodes (FIG. 4A). The temporary binders also add flexibility to the electrode pre-sintering, allowing the electrode sheet to be formed to shape. The electrode stack can then be laminated together and sintered into the final battery (FIG. 4B).

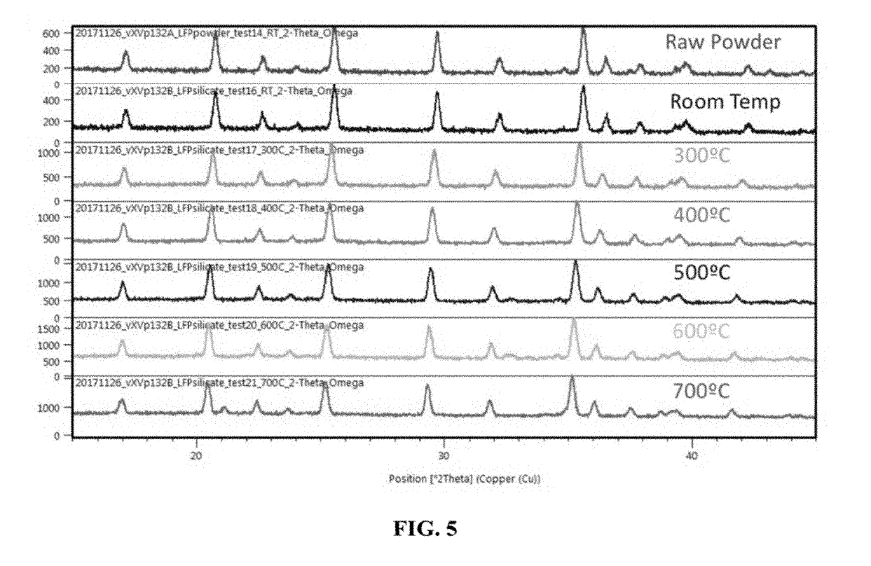

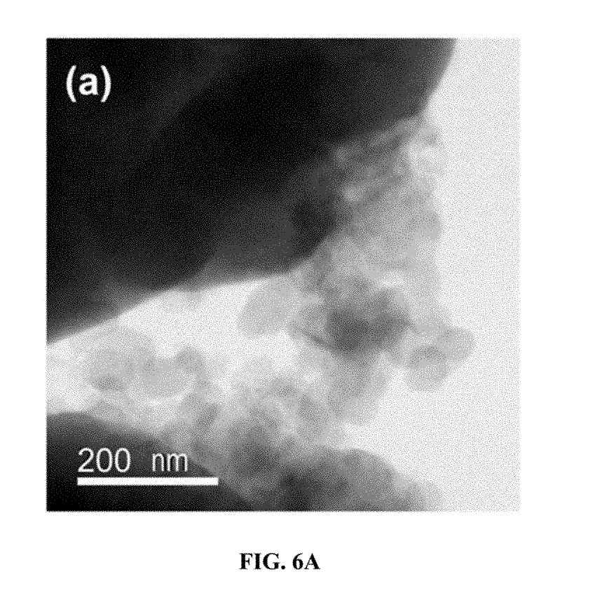

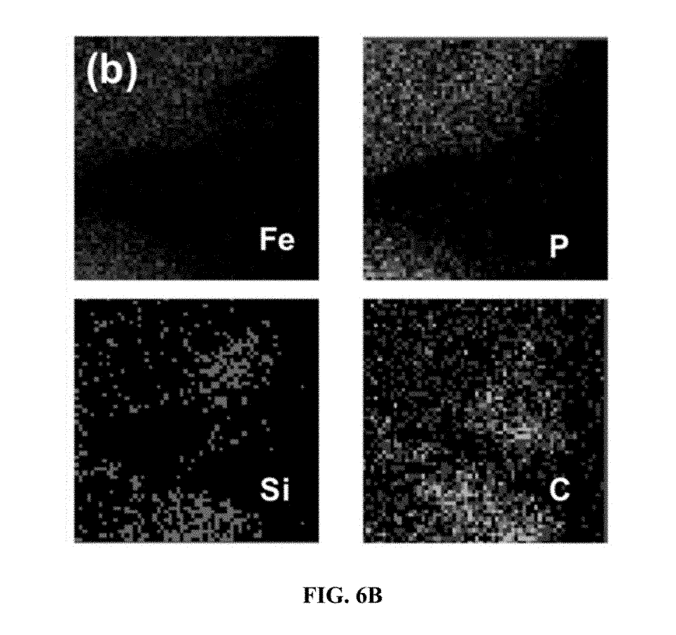

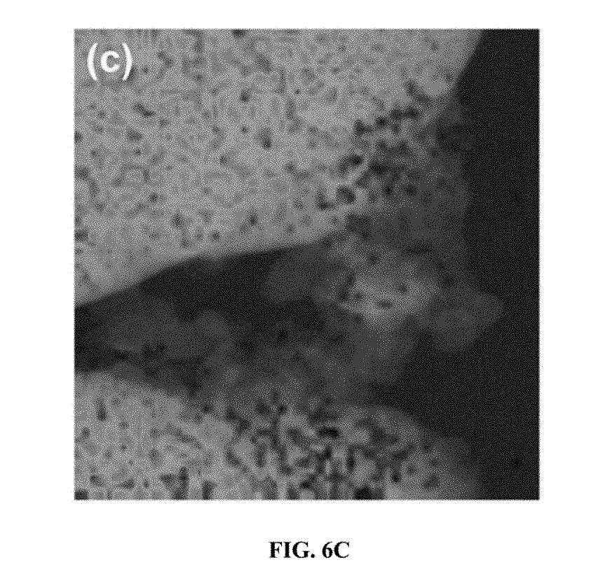

As soluble sodium silicates had not previously been employed as binders in intercalation batteries, compatibility with common active materials was evaluated. Mesoporous Carbon Microbeads (MCMBs) and Lithium Iron Phosphate (LFP) were chosen as active materials in order to demonstrate the feasibility of the SCB design. The silicate binder was shown to be highly compatible with both of these materials. X-ray diffraction performed on LFP electrodes using silicate binder (s-LFP) heated in situ showed no formation of impurity phases up to 700° C. (FIG. 5). TEM analysis with EDX performed on samples heat treated to 500° C. (FIG. 6) showed silicate colocalization at the interface between LFP and conductive carbon, demonstrating that silicate can function as an effective binder in the electrode. In addition, no crystalline silicate phases were found resulting from heat treatment to 500° C. using either TEM or XRD analysis despite the previously observed appearance of β-Na₂Si₂O₅ at 400° C. See Subasri, R., & Näfe, H. (2008). Phase evolution on heat treatment of sodium silicate water glass. Journal of Non-Crystalline Solids, 354(10-11), 896-900, which is incorporated by reference in its entirety. This can be due to partial substitution of lithium for sodium stabilizing the amorphous silicate phase.

### Battery Data

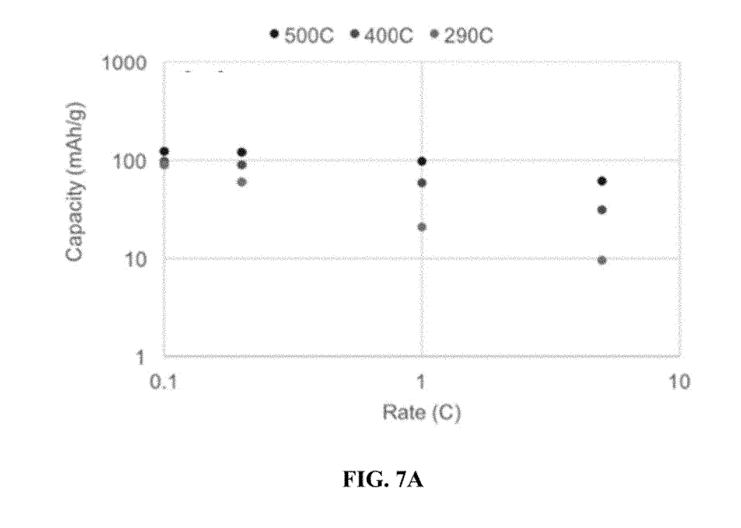

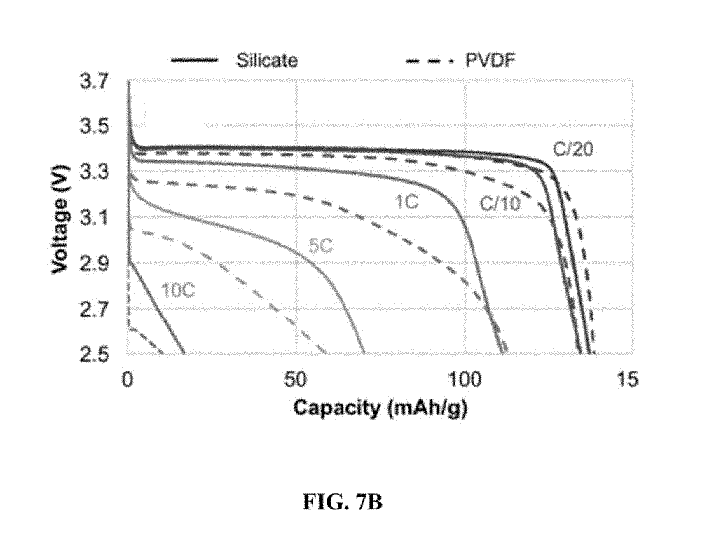

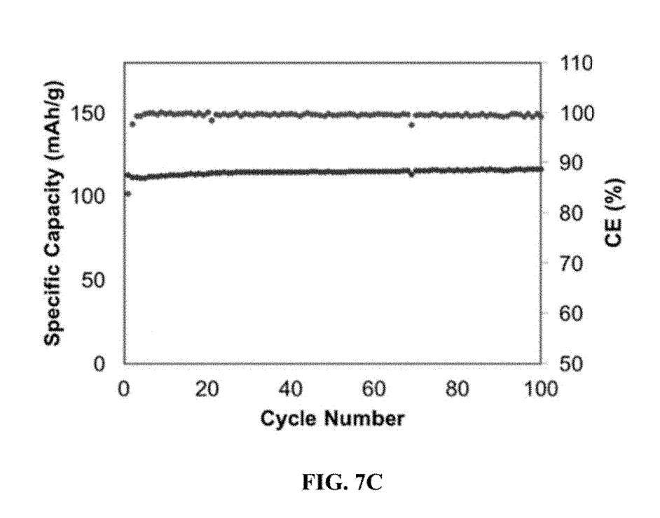

The electrochemical performance of silicate-based electrodes was optimized by adjusting heat treatment temperature, binder mass fraction, and conductive additive content. Results of heat treatment temperature optimization for LFP/silicate electrodes are shown in FIG. 7A. The electrode rate capability is optimized at 500° C., confirming the silicate/LFP compatibility observed via XRD and TEM as increasing heat treatment temperature improves performance.

A comparison between the novel silicate binder and a typical PVDF binder is shown in FIG. 7B. The silicate binder confers improved rate capability on the LFP cell. As the loading of the PVDF cell is slightly lower than the silicate cell (1.07 mgLFP/cm² PVDF electrode vs. 1.6 mgLFP/cm² silicate electrode), it is concluded that the improved rate capability is the result of improved charge transport resulting from the ionic silicate binder. This additionally demonstrates that no performance penalty is incurred as a result of employing the novel binder material.

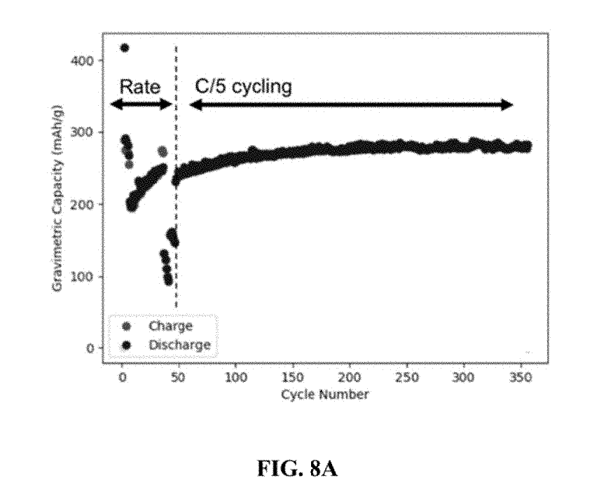

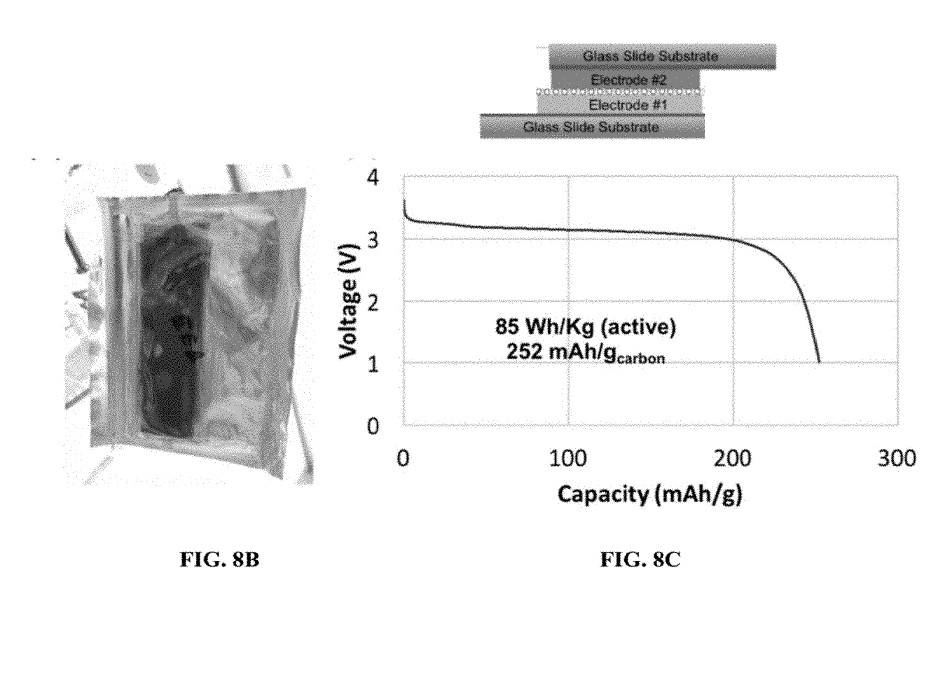

Long-term cycling tests are shown in FIG. 7C and FIG. 8A for LFP and graphite electrodes respectively. These data demonstrate that the silicate binder is compatible with each of these materials. Finally, electrochemical data from a full cell using an LFP/silicate cathode and a graphite/silicate anode is given in FIG. 8C. This cell was fabricated according to the scheme presented in FIG. 3, using a glass fiber separator and silicate binder paste in order to adhere the electrodes. It achieves 250 mAh/g based on the weight of graphite, which is the limiting electrode. Additionally, it achieves an energy density of 85 Wh/kg based on the active materials mass.

### Mechanical Data

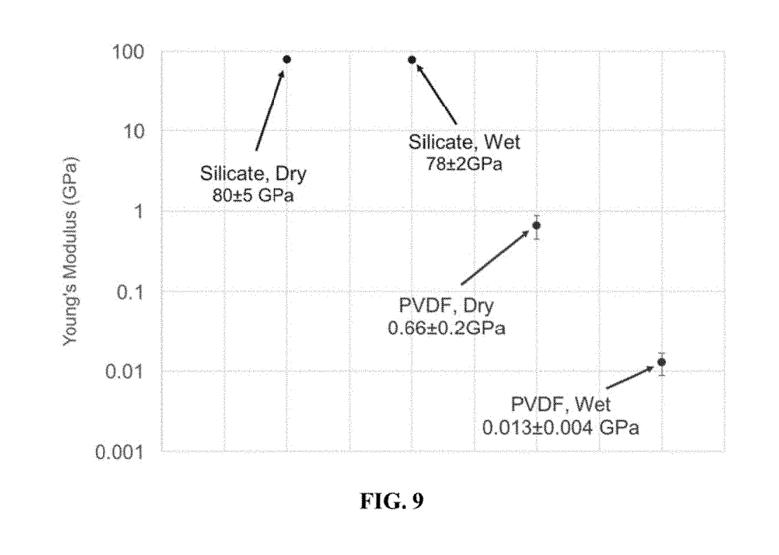

The mechanical properties of sodium trisilicate were compared to those of alternative binders that have been investigated for use in structural batteries. The distribution of load within an electrode requires a sufficiently stiff binder. As shown in FIG. 9, PVDF is a soft material with a Young's modulus of about 0.5 GPa. By contrast, the Young's modulus of sodium silicate is 71 GPa, and unlike PVDF it does not soften when exposed to electrolyte solvent (FIG. 9), whereas the modulus of PVDF decreases to 0.01 GPa. This imperviousness to electrolyte facilitates the production of rigid composite electrode engineering ceramics able to bear load.

Additionally, the fracture toughness of these electrodes was measured and found that it can be tuned by varying the amount of silicate and conductive carbon. The carbon black additive, used to improve the electronic conductivity of the electrode, decreases the toughness of the electrode while adding silicate (with additional carbon black) improves fracture toughness. This shows that silicate acts as an effective binder, holding the electrode together. In addition, the value measured for fracture toughness is within the regime expected for porous ceramic materials. Further mechanical tests are underway, showing the effects of structural additives on electrode strength.

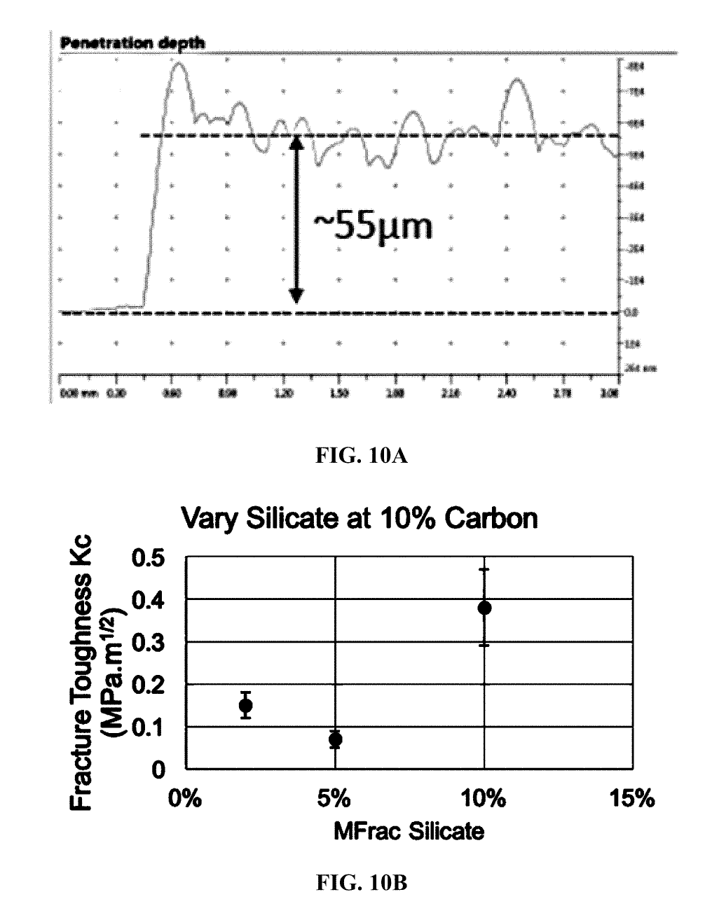

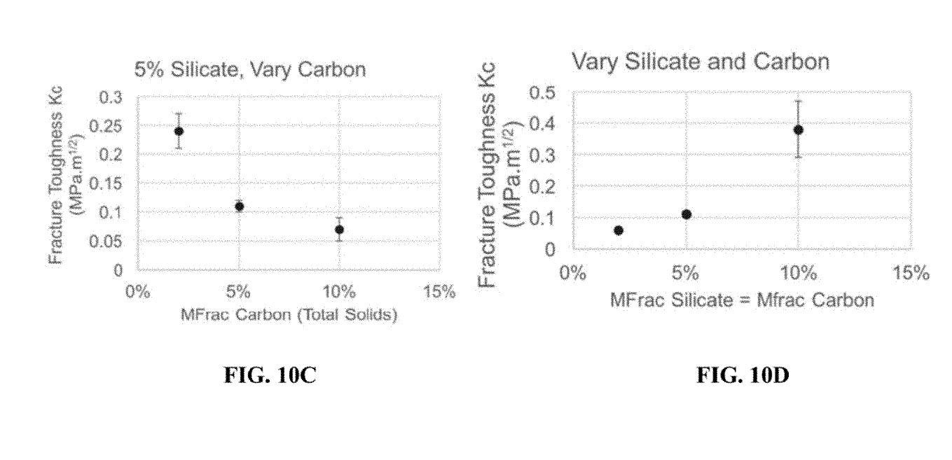

To evaluate the use of silicate as an electrode binder, LiFePO₄ (LFP) electrodes were made with various compositions as shown in Table 1, based on a standard slurry method. This slurry was doctor bladed as a 100 μm thick layer onto a glass substrate, dried, and heat treated to 500° C. During drying and sintering, the samples decreased in thickness by about 45% (FIG. 10A).

Table 1 shows electrode compositions used for heat treatment tests.

TABLE 1

| | | |
|---|---|---|
| Component | MTI Electrode | SCB Electrode |

| | | | |
|---|---|---|---|
| LiFePO₄ (LFP) | 93.5 | wt % | 80-96 wt % |
| Super P | 4 | wt % | 2-10 wt % |
| Binder | 2.25 | wt % | 2-10 wt % |

The fracture toughness K_{IC} of the samples was measured. K_{IC} is a measurement of a material's resistance to brittle fracture, and is thus a figure of merit in the evaluation of structural materials. It was hypothesized that increased silicate content would improve K_{IC} of the material, while increased conductive carbon content would lower K_{IC}.

FIGS. 10A-10D show that silicate functions as an effective binder in the system. A scratch test was used to measure K_{IC} of these samples. The results are presented in FIGS. 10B-10D. In these graphs, the mass fraction silicate binder and conductive Super-P carbon are shown. The remaining unspecified mass fraction is entirely LFP active material. As shown in FIG. 10C, increasing the amount of Super-P conductive carbon at 5 wt % silicate monotonically lowers K_{w}. This makes intuitive sense, as Super-P is a high surface area carbon with little structural integrity that is not expected to exhibit strong interactions with the active material. Thus, as its mass fraction increases the electrode becomes weaker.

Another intuitive trend is shown in FIG. 10B. This demonstrates that when the mass fraction of binder and conductive carbon are equal, increasing them monotonically increases K_{w}. As increasing Super-P content by itself weakens the electrode, this trend demonstrates that the silicate binder increases electrode toughness. Thus, silicate functions effectively as a binder material. The trend shown in FIG. 10B is somewhat less intuitive. This shows that increasing the silicate binder mass fraction at a constant 10 wt % Super-P does not monotonically increase K_{w} as might be expected. Instead, high silicate contents lead to high KIC while an intermediate 5 wt % silicate results in a K_{IC} minimum. Some clues as to the origin of this are to be gleaned from TEM data investigating the distribution of silicate in these samples (presented below). Micrographs show that silicate migrates to the carbon and to the interface between the carbon and the LFP. It is possible that at low silicate loading, the silicate is effective at bonding the LFP active material to the conductive carbon. Thus, fracture occurs when weak but elastic Super-P connections between electrodes break. As the silicate content increases to an intermediate level, it seems that the silicate covers the Super-P sufficiently to prevent its elastic deformation but does not form strong bonds between active materials in of itself. This results in low K_{IC}. At higher silicate loading, the silicate is clearly effective at bonding LFP particles to each other as shown by the trends in FIGS. 10B and 10D.

In order to carry out electrochemical tests, performance was first investigated as a function of heat treatment. Silicate-LiFePO₄ LFP (s-LFP) and silicate-Graphite (s-Graphite) electrodes were made using the composition shown in Table 2.

Table 2 shows electrode compositions used for heat treatment tests.

TABLE 2

| Component | Mass Fraction |
|---|---|
| Active Material (LFP or MCMBs) | 85 wt % |
| Super P | 10 wt % |
| Sodium Silicate | 5 wt % |

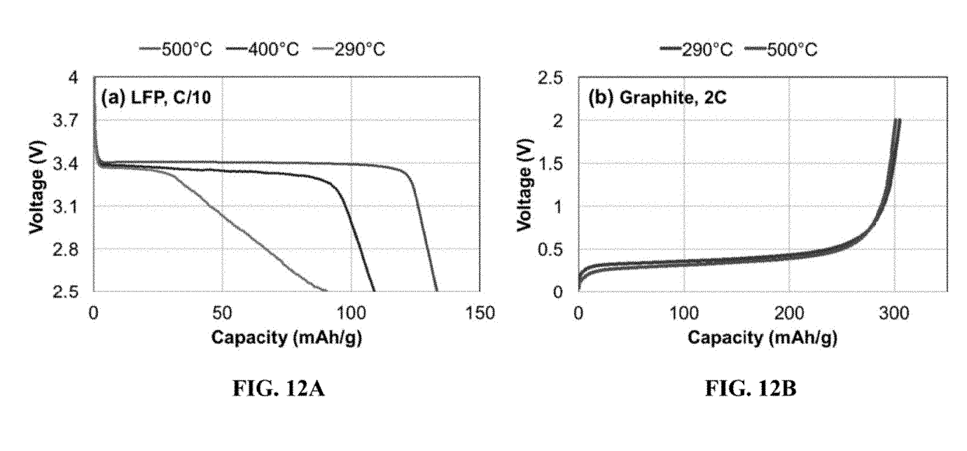

These electrodes were heated to 90° C. and held for two hours, then heated to a higher treatment temperature and held at this temperature for two hours. FIGS. 12A-12B show discharge data of half cells made using electrodes processed at various treatment temperatures. LFP shows a strong effect of heat treatment as evidenced in FIG. 12A, demonstrating an increase in capacity with heat treatment up to 500° C. At the low 290° C. treatment temperature, the voltage curve shows a long tail. This indicates that a significant fraction of the active material is not electrochemically accessible at the C/10 rate. As the treatment temperature is increased, the electrode evidently undergoes a transformation resulting in substantially improved capacity. Four potential reasons for this could be that (1) the silicate reacts with the LFP to change its bulk chemistry and heat treatment reverses this reaction, that (2) silicate and LFP react in order to produce a non-lithium-conducting layer that is removed by heat treatment, that (3) electrical pathways are improved by the heat treatment, or that (4) the silicate itself becomes more lithium conductive during heat treatment. The effect of this heat treatment is further investigated below via electrochemical cycling and transmission electron microscopy.

As shown in FIG. 12B, heat treatment temperature has little effect on graphite electrodes made using a silicate binder. This was expected, as graphite is intrinsically electrically conductive, chemically inert in the presence of silica, and highly lithium conductive.

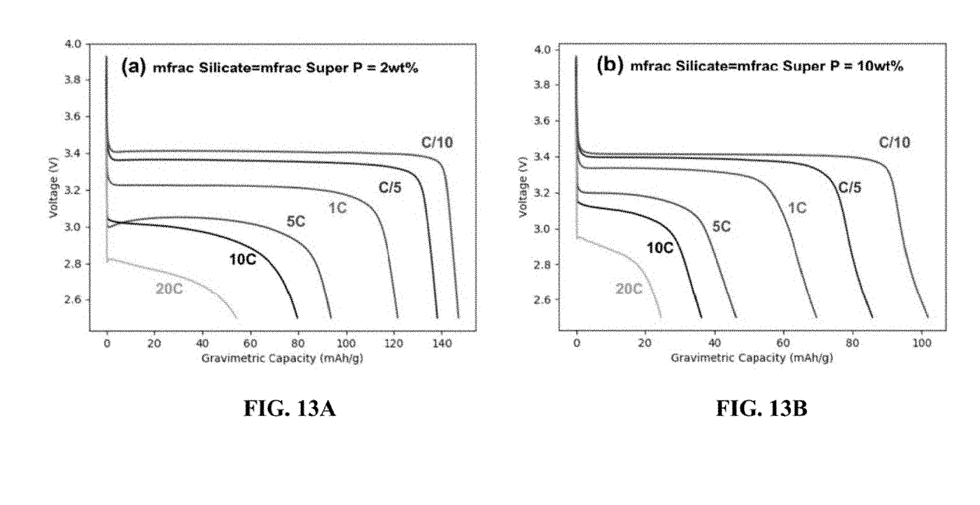

The composition of s-LFP electrodes using a silicate binder was varied as shown above in Table 1, using as a starting point the compositions tested for fracture toughness and the ratios used in MTI Corporation. Step by step recipe for preparing anode cathode electrode slurry.pdf. http://www.mtixtl.com/documents/121StepbyStepRecipeforPreparingAnode %20CathodeElectro deSlurry.pdf. (Accessed on Mar. 26, 2018), which is incorporated by reference in its entirety. This resulted in discharge curves at various C-rates as shown in FIGS. 13A-13B.

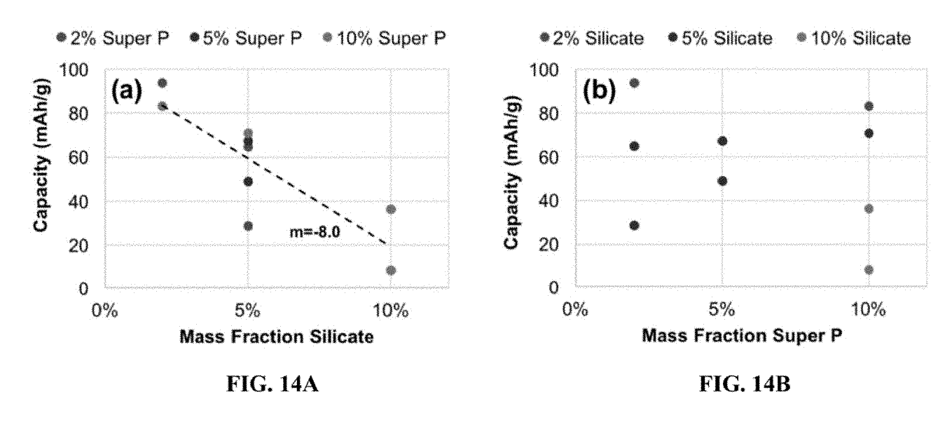

Capacity at the 5C rate was plotted as a function of composition, and presented in FIGS. 14A-14B. This current was chosen to be an intermediate cycling rate expected to be strongly affected by differences in charge transport. FIG. 14A shows the effect of silicate content on 5C rate. As demonstrated by the strongly sloped trend line, increasing silicate content decreases capacity at the 5C rate irrespective of Super P content. By contrast, as shown in FIG. 14B, these data do not show a strong overall dependence of 5C capacity on Super P mass fraction. A linear regression performed on the data in FIG. 14B yields a slope of −1.6, or 20% of the slope of the data in FIG. 14A. This indicates that silicate content affects rate and that Super P content does not substantially affect rate, under these conditions.

An interpretation of the data in FIG. 14B is that the effect of Super P on rate depends on the silicate content. At low (2%) silicate content, there appears to be little effect of Super P on rate. At high (10%) silicate content, even large amounts of Super P do not lead to high 5C rate capability. For intermediate (5%) silicate concentration, increasing the amount of Super P appears to lead to higher 5C capacity.

These rate capability results elucidate the mechanism behind improvement of C/10 capacity with heat treatment shown in FIGS. 14 and 7A. As Super P content does not seem to substantially affect rate under these conditions, electrical pathways are likely not responsible for the improvement in rate observed with increasing heat treatment temperature. By contrast, the fact that silicate content greatly affects rate suggests looking to chemical mechanisms impeding Li⁺ transport for the origins of this effect.

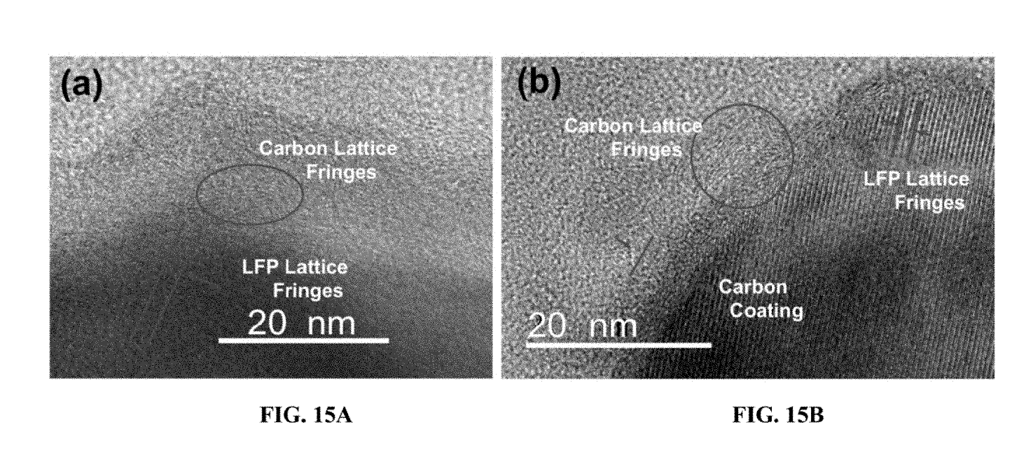

In order to determine the origins of the rate behavior observed in s-LFP electrodes, they were investigated via transmission electron microscopy (TEM). Samples of s-LFP made as described in the methods were examined. Electrodes with no heat treatment were compared to electrodes heated to 500° C. so that the effect of heat treatment could be observed. TEM micrographs revealed that the s-LFP electrodes exhibited crystalline LFP regardless of heat treatment, as demonstrated by the lattice fringes observed (FIGS. 15A-15B). Furthermore, the electrodes were coated with a 5-25 nm thick carbon layer deposited on the LFP as received. See MTI Corporation. Lifepo4 powder for li-ion battery cathode, 200 g/bottle-eq-lib-lfpo-s21. http://www.mtixtl.com/LiFePO4PowderforLi-ionBatteryCathode-EQ-Lib-LFPO-S21.aspx. (accessed on Mar. 29, 2018), which is incorporated by reference in its entirety. This layer is expected to be both lithium and electron conducting, and to thus promote charge transport kinetics. This is consistent with the rate behavior observed in FIG. 14B, in that only a small amount of carbon is needed to promote electrical conductivity. Increasing the amount of carbon would thus not be expected to improve rate capability.

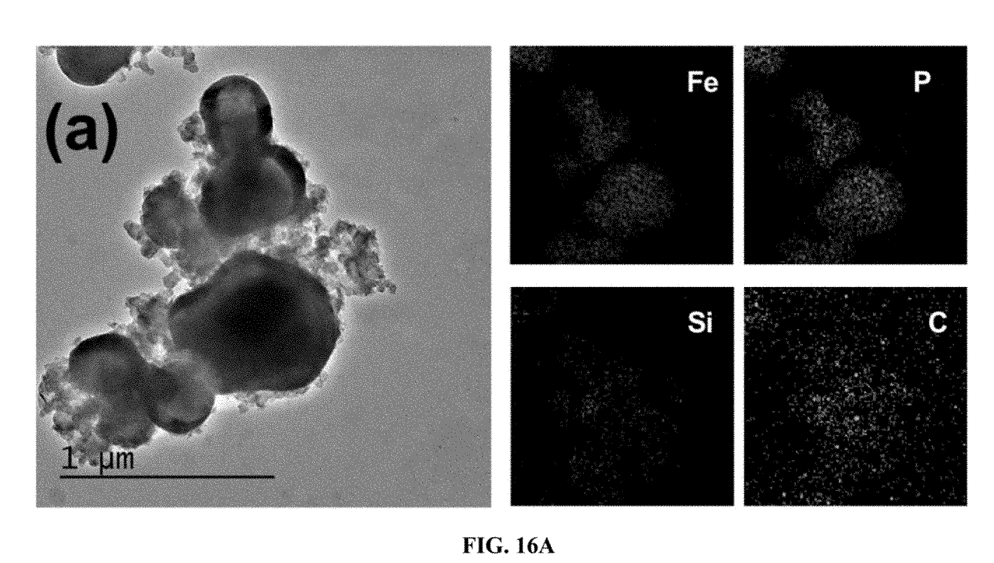

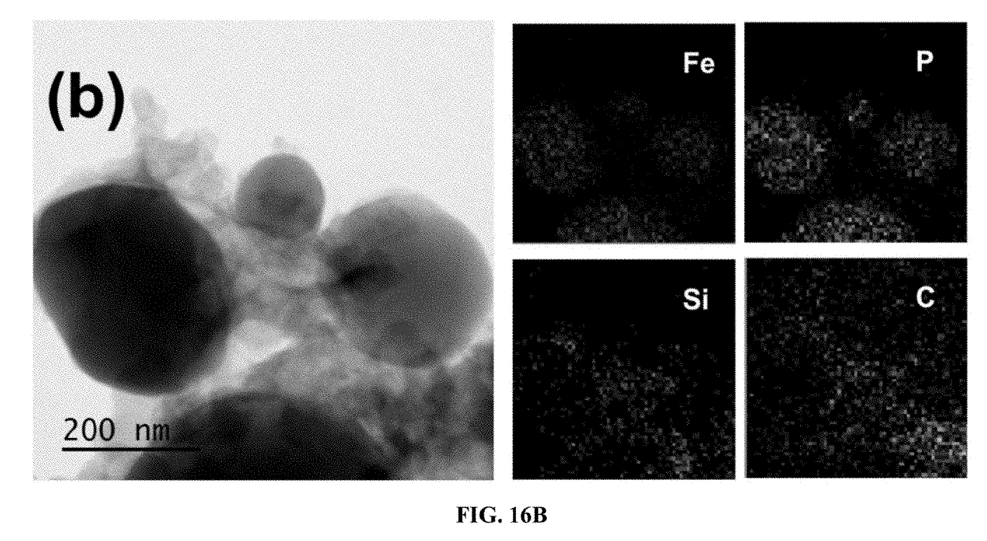

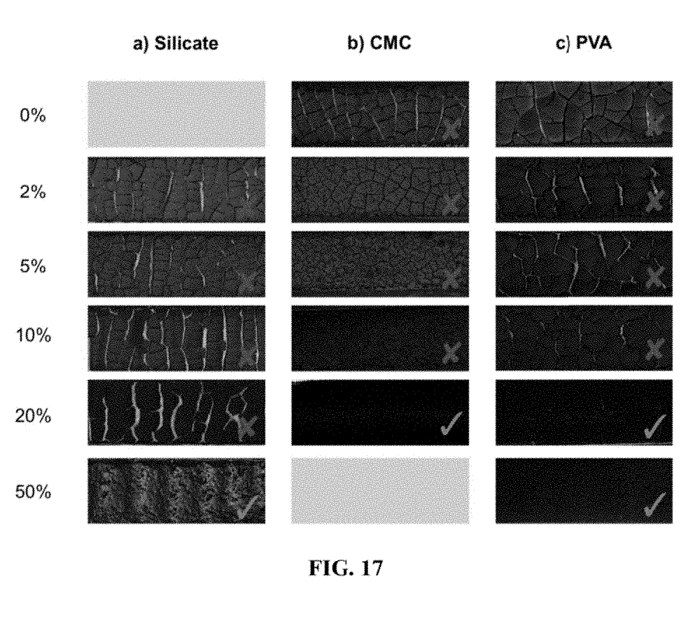

Elemental mapping provides further clues as to how the rate behavior of the electrodes is affected by composition. As shown in FIGS. 16A-16B, iron and phosphorous are co-localized as expected in LiFePO₄. Carbon is ubiquitous in the electrode, both coating the active material surface and forming conductive interconnects between active particles. Silicate, meanwhile, is largely localized in the conductive carbon and at the interfaces between this carbon and the active material (see FIG. 6). At this composition, it does not primarily coat the active LFP. This is consistent with the rate dependence on composition observed in FIGS. 14A-14B. As silicate has an affinity for the conductive carbon, when the silicate content is small it does not influence rate because it mainly coats conductive carbon in-between active particles. In this location it does not have a substantial effect on ion transport into and out of the particles themselves. When the silicate content is high compared to the Super P carbon, it may coat the active materials and block ion transport.

During TEM investigations of the s-LFP electrodes heated to 500° C., it appeared that crystalline silicate was not present. This is surprising, as β-Na₂Si₂O₅ is known to form when waterglass is heated above 400° C. The lack of crystalline silica was confirmed with XRD FIG. 5). It is possible that the amorphous silicate is stabilized at high temperatures by either interactions with conductive carbon, or by ion exchange with the LFP.

Evidence of ion exchange was observed from elemental mapping in TEM as shown in Table 3. The amount of detectable sodium decreases with heat treatment by more than a factor of three. A likely explanation for this is that sodium is exchanged with lithium in the iron phosphate. As sodium is light and difficult to detect using EDX, sodium in the LFP particles may not be observed. Because the primary source of sodium in the electrode is the silicate, ion exchange of lithium for sodium may appear to remove sodium from the system. This is consistent with the fact that crystalline β-Na₂Si₂O₅ was not observed, as ion exchange would be expected to stabilize the amorphous silicate.

Table 3 shows atomic ratio of sodium to silicon measured from elemental mapping in TEM. Detectable sodium decreases with heat treatment, suggesting ion exchange with the LFP.

TABLE 3

| Heat Treatment | Na/Si Atomic Ratio |
|---|---|
| None | 1.8 +/− 0.6 |
| 500° C. | 0.54 +/− 0.16 |

### Addition of a Temporary Binder to Electrodes

Following the process outlined above for electrode fabrication, aqueous slurries are prepared and coated onto a substrate. For the previous tests, slurries were cast onto a substrate which was used as a current collector in the ultimate battery. In order to make energy dense SCBs and to make them easier to fabricate and ultimately to manufacture, it is desirable to remove these electrodes from their substrates and handle them as freestanding films. However, the electrodes as deposited in previous sections were not sufficiently mechanically robust. The addition of organic polymers was thus investigated in order to increase their durability before sintering.

Two organic polymers were chosen, poly(vinyl alcohol) (PVA) and sodium carboxymethycellulose (CMC) for investigation as binders in these freestanding films. These polymers were chosen because both are water soluble and frequently used in films in order to prevent film cracking and to improve robustness. Furthermore, they can be used as temporary binders during the electrode fabrication process as they will decompose during heat treatment and lose 65% of their initial mass (see El-Sayed, K H Mahmoud, A A Fatah, and ADSC Hassen. Dsc, tga and dielectric properties of carboxymethyl cellulose/polyvinyl alcohol blends. Physica B: Condensed Matter, 406(21):4068 {4076, 2011., which is incorporated by reference in its entirety) in order to leave the rigid silicate binder.

Tests were done to evaluate what loading of silicate, CMC, and PVA are necessary to produce crack-free films. Slurries were made using a 1:1.4 ratio of solids to water in the solution. The slurries consisted of lithium iron phosphate, water, and enough polymer to result in the desired mass fraction in the dry film. These films were cast 1050 μm thick onto a paper substrate. This thickness was chosen because it results in approximately 470 μm thick dry films, substantially thicker than any battery electrode that would be expected to exhibit good kinetics. Thus, linear elastic fracture mechanics would predict that a composition immune to film cracking at this thickness will be strong enough to resist cracking at any reasonable battery electrode thickness. Results are shown in FIGS. 4A-4B.

These results show that addition of significant amounts of binder can be used to produce crack-free electrode films. CMC and PVA are both able to result in crack-free films at 20 wt %, while more silicate (between 20-50 wt %) is required if only inorganic polymer is used.

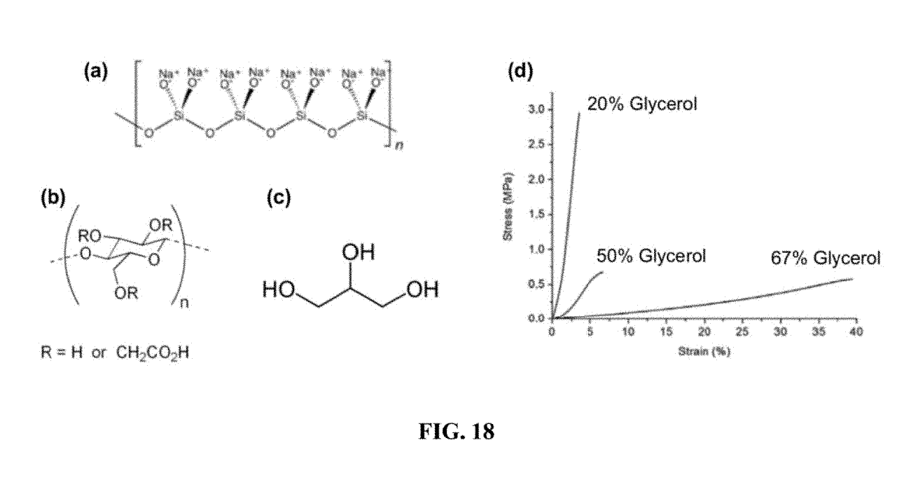

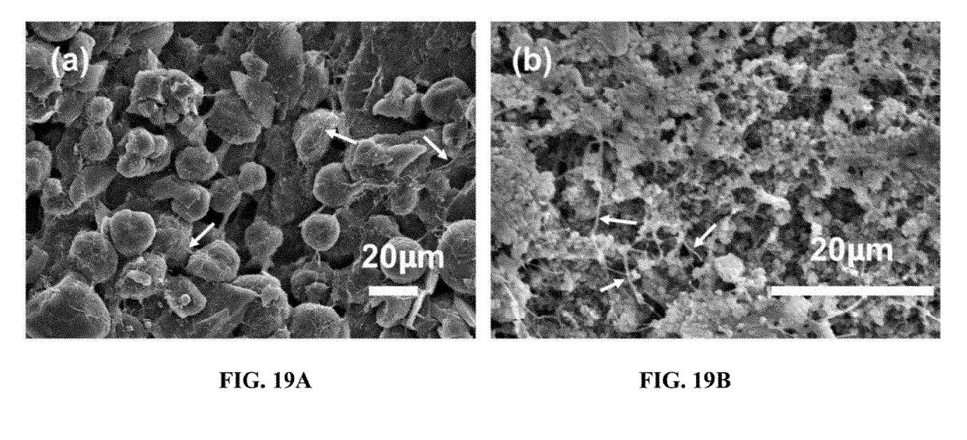

The films can be made not only freestanding but flexible with the addition of a plasticizer to increase the elasticity of the CMC. This is shown in FIG. 18, in which addition of glycerol causes the strain at failure to increase by a factor of eight. The data in FIG. 18 panel (d) was published in the literature in De Britto, D. et al. Int. J. Pol. Anal. Char., 17: 302-311, 2012, which is included by reference in its entirety. Additionally, glycerol is a small molecule (FIG. 18 panel (c) with a boiling point of 290° C. Thus, it is expected to entirely evaporate during heat treatment as the CMC is pyrolized. The residual binder required as shown in FIG. 4 can therefore be effectively reduced, resulting in a material post-sintering that has a very low organics content.

### Reinforcing SCB Electrodes

Linear carbon-based structures on several length scales can be used to reinforce structural materials. These are surveyed in Table 4. They span dimensions from thin single-walled nanotubes to the graphitic carbon fiber used in industrial composites.

Table 4 shows dimensions of typical carbon-based materials used to reinforce composites span orders of magnitude in both length and width. Given are typical values for materials that are easily obtained from commercial sources.

TABLE 4

| | | |
|---|---|---|
| Reinforcement | Width | Length |

| Single-Walled Carbon Nanotubes | 0.45-3 | nm | Up to 2 μm | |
|---|---|---|---|---|
| Multi-Walled Carbon Nanotubes | 5-100 | nm | 1-10 | μm |
| Carbon Nanofiber | 70-200 | nm | 50-200 | μm |

| | | | |
|---|---|---|---|
| Carbon Fiber | 5-10 | μm | mm - meters |

The use of multi-walled carbon nanotubes (MWCNTs), carbon nanofiber (CNF) and chopped carbon fiber (CCF) materials as both structural support and as conductive additive was explored, initially without CMC so that the effect of reinforcement could be easily evaluated. It was found that addition of 10 wt % CCF to replace Super-P resulted in immense film cracking. MWCNTs produced electrodes that were brittle upon being removed from their substrates. Films reinforced with CNF exhibited improved mechanical performance.

### Separator Development

As shown in FIG. 2, the SCB design employs a ceramic binder throughout layers of the battery stack including both electrodes and the separator. In order to achieve this, it was necessary to design a separator paste using the silicate binder. The SCB electrode composition described above was used as a starting point for the binder paste, with 0.5 μm diameter SiO₂ particles replacing active material particles.

The effect of silicate content on rate capability was expected to be substantially different in the separator compared to the electrodes. This is because Li⁺ needs only to pass through the separator during cycling, not to intercalate in and out of separator particles. Slow Li⁺ transport kinetics through the silicate into and out of the active material substantially limit silicate content in the electrodes, whereas only pore blocking is expected to limit silicate content in the separator.

Thus, separators with varying silicate content were fabricated. The base composition for a 10 wt % silicate separator is described in Table 5. The silicate loading was varied, maintaining a constant mass fraction of SiO2, CMC, and glycerol in the wet slurry. Slurries were coated onto a glass fiber tow and dried. Similar to the electrodes, this resulted in a flexible film. These films were heated to 500° C. in argon in order to sinter the separator and simulate the heat treatment process that an SCB undergoes during processing.

Table 5 shows example composition of separator paste at various processing steps. The wet slurry was coated onto a glass fiber tow and dried. The tow was subsequently heated to 500° C. to result in the final composition. Pastes were made varying the silicate, SiO₂ and water content in order to result in diffeeent silicate compositions as described in the text. All composition values in this table are given in wt %.

TABLE 5

| Component | Wet Slurry | Dry Film | Sintered Separator |
|---|---|---|---|
| Silicate | 2.7% | 7.4% | 10% |
| SiO2 Particles | 22% | 61% | 85% |
| CMC | 3.9% | 11% | 5% |
| Glycerol | 7.8% | 21% | 0% |
| Water | 82% | 0% | 0% |

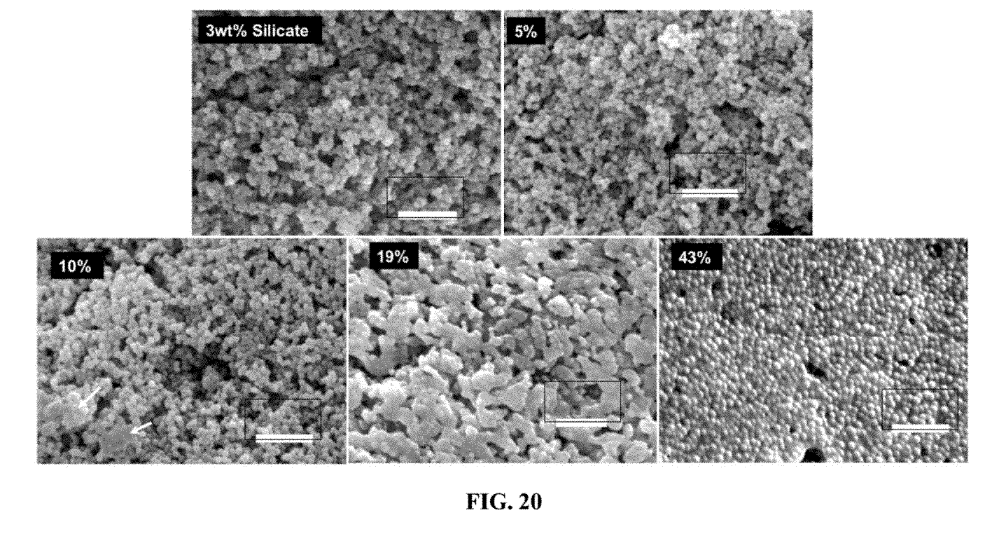

Morphologies of samples with varied silicate composition are shown in FIG. 20. As the silicate composition is varied, samples up to 10 wt % silicate show very little aggregation of SiO₂ particles. The morphology of these samples is largely a porous film of individual particles. At 10 wt %, there begins to be some aggregation as shown by the arrows in FIG. 20. The 19 wt % sample is composed of 10-20 μm aggregates of SiO₂, while the 43 wt % silicate sample is a uniform film of silica with particles embedded in it.

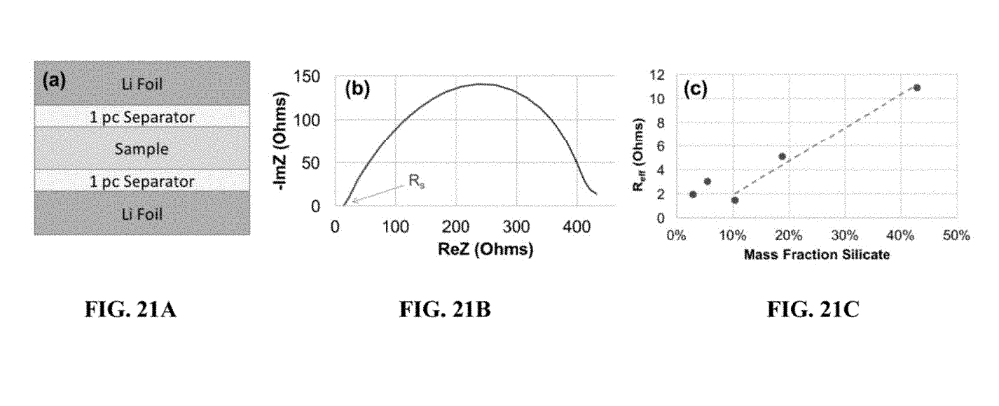

The resistance of these films was tested using electrochemical impedance spectroscopy (EIS). Cells were made using the configuration shown in FIG. 21A and measured as described previously. See Andrej Metlar. A study on high energy density additive-free sintered licoo2 electrodes for lithium-ion batteries. Master's thesis, Swiss Federal Institute of Technology Zurich, 2011, and Indrajeet V Thorat, David E Stephenson, Nathan A Zacharias, Karim Zaghib, John N Harb, and Dean R Wheeler. Quantifying tortuosity in porous li-ion battery materials. Journal of Power Sources, 188(2):592-600, 2009, each of which is incorporated by reference in its entirety. The solution resistance Rₛ was taken to be the high-frequency intercept of the Nyquist impedance plot with the real axis, as shown in FIG. 21B. Rₛ was measured for experimental samples as well as control samples containing no sample. The resistance corresponding to transport through the separator and other device components was controlled for by calculating the effective resistance corresponding to transport through separator samples, taken to be:

R_{Eff}=R_{S,Sample}−R_{S,Control}

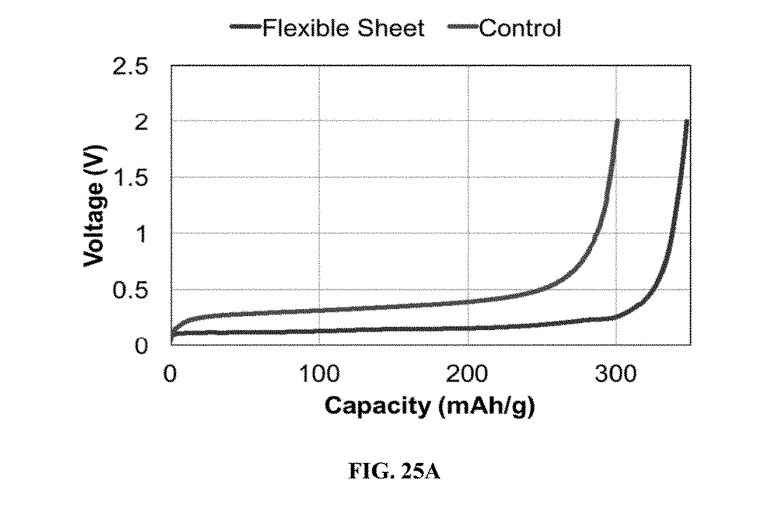

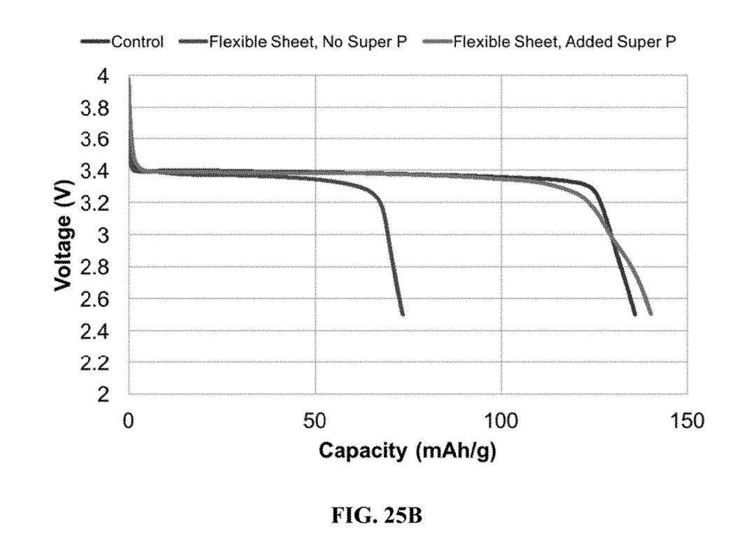

This R_{Eff} is shown in FIG. 25C. As shown in FIG. 21C, R_{Eff} is approximately constant for compositions under 10 wt % silicate and increases approximately linearly from 10 wt % to 43 wt %. This is highly compatible with the separator morphology shown in FIG. 20. As shown in scanning electron micrographs, sample morphology changes very little with the addition of silicate under 10 wt %. The morphology in this case corresponds mainly to 0.5 μm diameter SiO₂ particles with very little apparent volume fraction devoted to silicate filler. At 10 wt % aggregates of particles begin to show with a substantial volume fraction devoted to silicate.

These electrochemical results suggest that at high volume fractions silicate, electrolyte is displaced and/or the tortuosity of the separator increases. The result is to increase the ionic resistance of the separator.

### SCB Fabrication

The components of an SCB corresponding to both electrodes and the separator described above were combined into a full SCB. SCBs were initially made on glass substrates, obviating the need for CMC and CNF as the electrodes were not designed to be freestanding. This configuration is shown in FIG. 8C. Two glass substrates were coated with current collector paste purchased from Ted Pella, using a carbon current collector for the positive electrode and a nickel paste for the negative electrode. SCB electrodes were coated onto these substrates, heat treated, and layered with glass fiber and a separator paste. This whole battery stack was packaged and cycled.

The resulting battery was initially charged at C/20 to 4V, and shows an excellent capacity when discharged at C/20 (FIG. 8C). In this cell, the negative electrode limited capacity and its mass was therefore used to normalize capacity. The loading of components in this configuration are shown in Table 6. As shown, the graphite represents an area specific capacity of 1.3 mAh/cm² which is in the range needed for commercial cells. This cell has room for further optimization, but represents a proof of concept of the feasibility of the SCB approach.

Table 6 shows composition of SCB on glass slide substrates shown in FIGS. 8A-8C. As shown, the active materials represent 28% of the mass loading of this cell. There is room for further optimization, both by increasing the loading fraction of the active materials and improving the capacity matching of the cell. Loadings of electrodes are given based on entire electrode mass, while area specific capacities are calculated by multiplying the theoretical specific capacity by the active material loading.

TABLE 6

| | Loading | Fraction Total | Area Specific |
|---|---|---|---|
| Component | (mg/cm2) | Loading | Capacity |
| Carbon Current Collector | 4.4 | 4.2% | — |
| LiFePO4 Electrode | 26 | 24% | 3.7 mAh/cm2 |
| Glass Fiber Separator | 7.7 | 7.3% | — |
| Separator Paste | 13 | 12% | — |
| Electrolyte | 38 | 35% | — |
| Graphite Electrode | 4.2 | 4.0% | 1.3 mAh/cm2 |
| Nickel Current Collector | 13 | 13% | — |

The fabrication process for SCBs was extended based on flexible freestanding sheets as described above. These sheets were made using CMC and CNF in the electrodes, and CMC combined with silica particles and glass fiber in the separator. The fabrication process is shown in FIG. 4. Freestanding sheets composed of both electrodes and separator were fabricated, and laminated with excess separator paste. This resulted in a flexible trilayer sheet which could be folded into shape on a mold and dried. The resulting battery was heat treated, resulting in a rigid composite maintaining the shape of the mold.

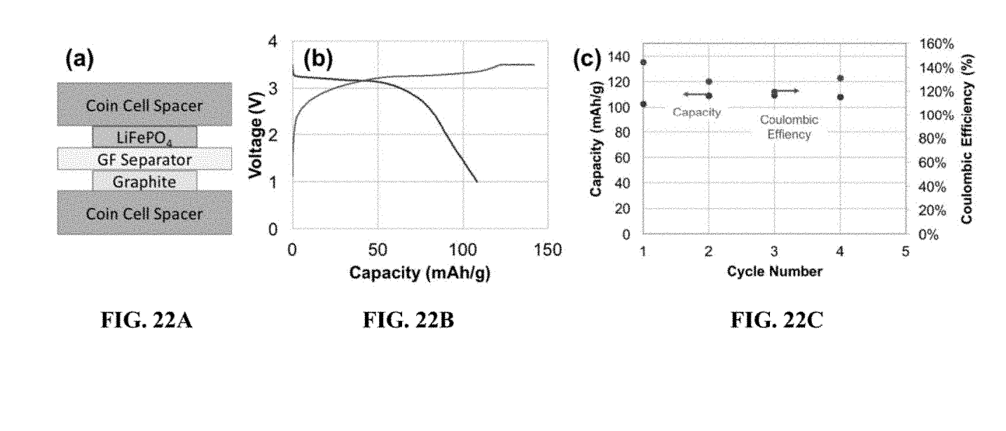

To assess the electrochemical performance of this production method, batteries were made from freestanding sheets cut to fit into a coin cell casing. These sheets were laid up as shown in FIG. 4 to make batteries with the cross-section shown in FIG. 22A. These were placed into coin cells and cycled. FIGS. 22B-22C show some cycling results from these cells at C/20. Table 7 shows the composition of these cells at the stack level. This configuration represents an improvement in the capacity matching of the electrodes as compared to the glass substrate samples. The separator paste with 3% silicate loading was used in this sample in order to facilitate ion transport. However, the total thickness of the paste-coated glass fiber was 137 μm. Subsequent cells will lower the separator thickness to improve rate.

Table 7 shows composition of SCB on glass slide substrates shown in FIG. 22. This represents an improvement in capacity matching compared to the cell fabricated on glass slides shown in FIGS. 8A-8C and Table 6. The graphite area specific capacity is within the range required for commercial cells.

TABLE 7

| | Loading | Fraction Total | Area Specific |
|---|---|---|---|
| Component | (mg/cm2) | Loading | Capacity |
| LiFePO4 Electrode | 32 | 37% | 3.65 mAh/cm² |
| Total Separator | 18 | 21% | — |
| Electrolyte | 27 | 31% | — |
| Graphite Electrode | 9.4 | 11% | 2.3 mAh/cm² |

### Mechanical Properties of Structural Ceramic Batteries

For evaluation of SCB mechanical properties, full cells were made as described above from freestanding electrode and separator sheets. These sheets contained a CMC temporary binder as well as CNF. The sheets were laminated into full cell stacks using excess separator paste, dried, and heat treated to 500° C. for two hours in an argon atmosphere.

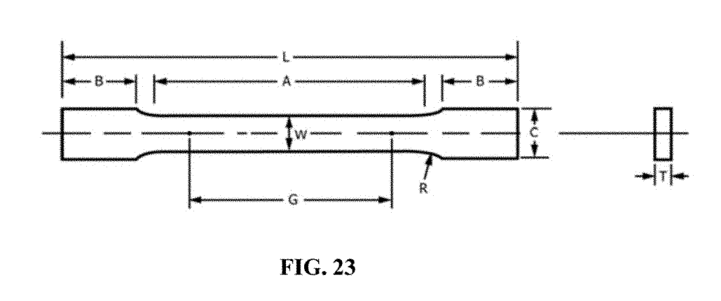

The samples used for mechanical tests were cut into a dogbone shape following the ASTM E8 standard plan shown in FIG. 23. Samples were made using the ‘subsize specimen’ dimensions, where G=25 mm, W=6 mm, and L=100 mm. This sample size was chosen in order to allow easy processing in a 12 cm deep furnace. This standard is designed to be used for the tensile testing of electrically conductive materials.

Composite materials require both strong and tough components in order to result in a robust composite structure. With this in mind, some samples were treated with poly(ethylene oxide) (PEO) before tensile testing. High molecular weight (N=5,000,000) PEO was used in order to provide maximal toughness at a low mass fraction of the total composite. PEO was chosen due to its well-known propensity to conduct Li⁺ and therefore to improve structural performance without deteriorating rate capability.

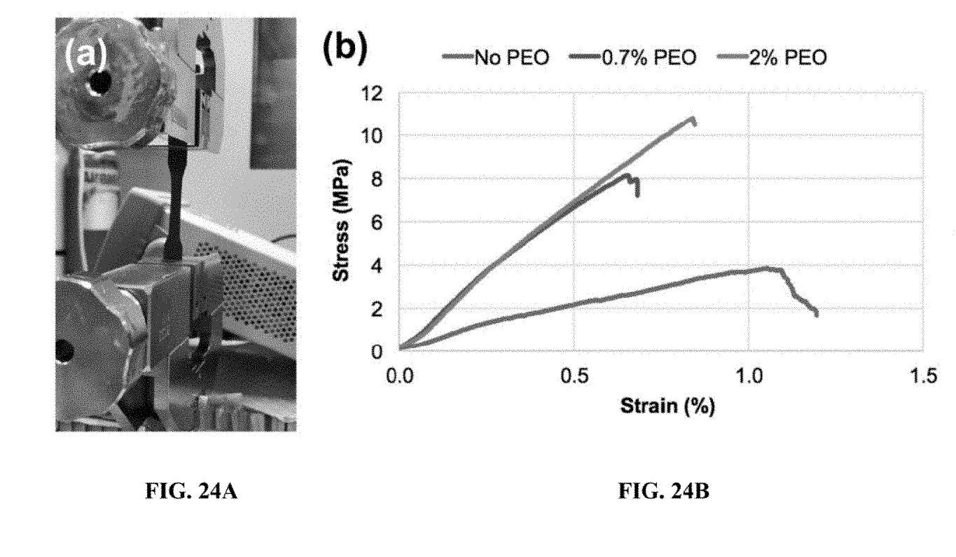

Tensile test results are shown in FIG. 24B. Composites exhibited 3.9 MPa tensile strength without PEO, which increased to 11.5 MPa with the addition of 2 wt % PEO. As expected, samples undergo brittle failure. The cell stack achieves an ultimate tensile strength (UTS) of 3.9 MPa with no PEO added. This relatively low strength is due to the brittle failure of individual struts at low deflection. Once an individual strut fails, it is useless in bearing further load. PEO was therefore expected to improve the mechanical properties of the structure by coating struts and allowing them to deform while still contributing to structural integrity.

The result of adding small amounts of PEO is also shown in FIG. 24B. As shown, the addition of PEO increases the stiffness of the material. It also increases the UTS of the battery stack by nearly a factor of three to 11.5 MPa. This series of tests demonstrates that SCBs can be fabricated that are able to bear load, and points to ways in which their performance might be improved further.

FIGS. 25A-25B demonstrate that electrodes made with flexible sheets have adequate capacity. Graphite electrodes show excellent charge transport in FIG. 25A. Samples made with flexible sheets (ie. added CMC) achieve ˜350 mAh/g graphite. C/10 delithiation shown in FIG. 25A. In LFP electrodes, flexible sheet samples achieve similar performance to control (rigid) samples (FIG. 25B). C/10 lithiation shown in FIG. 25B.

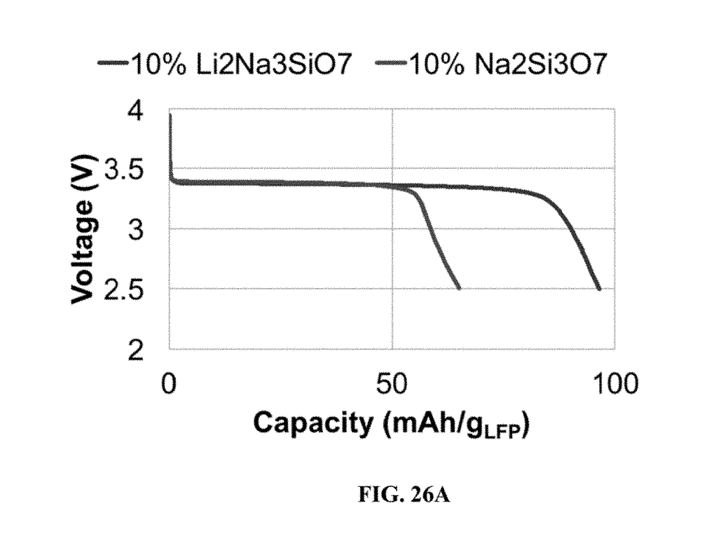

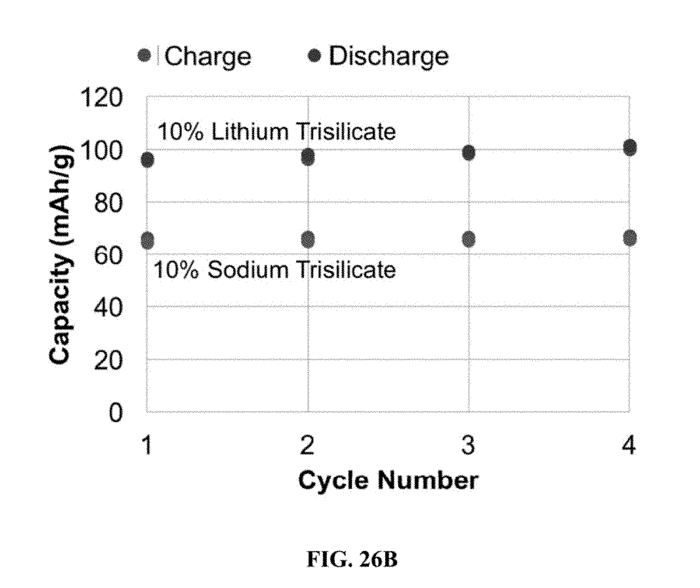

FIGS. 26A-B compare different inorganic binders at high binder content. Both of the electrodes characterized contain 80 wt % lithium iron phosphate active material, 10 wt % Super-P conductive carbon, and 10 wt % inorganic silicate binder. In FIG. 26A, discharge curves of these two electrodes at C/10 are compared. It is shown that for this electrode composition, which contains a high amount of silicate binder, the discharge capacity of the sodium silicate based electrode is 65 mAh/g while the discharge capacity of the lithium silicate based electrode is 98 mAh/g. FIG. 26B shows cycling data for these two electrodes over several cycles, demonstrating that both electrodes are cyclable. Together, these datasets demonstrate that inorganic binder chemistries other than sodium trisilicate can be used advantageously in Structural Ceramic Battery electrodes.

Table 8 shows that the energy density and tensile strength is similar to Ping Liu, Elena Sherman, and Alan Jacobsen. Design and fabrication of multifunc-tional structural batteries. Journal of Power Sources, 189(1):646-650, 2009, which is incorporated by reference in its entirety. However, the chemistry offered by Liu et al. results in worse charge transport than control samples (as demonstrated by the worse electrochemical capacity of the structural electrode compared to the conventional electrode shown in in Liu et al) but the structural ceramic batteries do not (as demonstrated in FIG. 7B). With better capacity matching >200 Wh/kg energy density will be achieved. In addition, the structural ceramic batteries are stiffer than Liu et al, achieving a tensile modulus of 1.4 GPa. Further, Ekstedt does not give cycling data, and it is unclear how their energy density is calculated.

Table 8 shows comparisons of characteristics and performance of the structural ceramic battery with the prior art.

TABLE 8

| | Energy | Tensile | Tensile | Bending |
|---|---|---|---|---|
| | Density | Strength | Modulus | Stiffness |
| Batteries | (Wh/kg) | (MPa) | (GPa) | (N/mm) |
| Liu, J Pwr Src 2009 | 35 | 12 | 0.65 | — |
| Ekstedt, Plastics and | 116* | — | 3.5 | — |
| Rubber Comp. 2010 | | | | |
| Yancheng, J. Intell. | 102 | — | — | 1941 |
| Mat. Sys. Struct., 2017 | | | | |
| Structural Ceramic | 30.0 | 11.49 | 1.4 | — |
| Batteries | | | | |

Other embodiments are within the scope of the following claims.

What is claimed is:

1. A battery comprising:
a porous anode having an anode surface;
a cathode having a cathode surface; and
a separator between the porous anode and the cathode and having a separator surface,
wherein each of the anode surface, the cathode surface and the separator surface include a binder including an inorganic material, wherein the binder adheres the porous anode, the cathode and the separator together.

2. The battery of claim 1, wherein the inorganic material includes a silicate, a phosphate, a borate, an aluminate, a sulfate, a nitride, or a combination thereof.

3. The battery of claim 1, wherein the binder includes a soluble sodium silicate.

4. The battery of claim 1, wherein the battery is a component of a device, a vehicle or a handheld device.

5. The battery of claim 1, further comprising an electrolyte.

6. The battery of claim 5, wherein the electrolyte is in a liquid, a gel or a solid form.

7. The battery of claim 1, wherein the binder functions as an electrolyte.

8. The battery of claim 1, further comprising a filler in the separator.

9. The battery of claim 8, wherein the filler includes silica powder or glass fiber.

10. The battery of claim 1, wherein the battery is flexible.

11. A method of producing a battery comprising:
casting an anode layer on a first substrate;
casting a cathode layer on a second substrate;
laminating the anode layer and the cathode layer on either side of a separator layer using a binder including an inorganic material; and
annealing the anode layer, cathode layer and the separator layer.

12. The method of claim 11, further comprising casting an anode layer from water-based slurries.

13. The method of claim 11, further comprising casting an cathode layer from water-based slurries.

14. The method of claim 11, wherein the annealing is carried out between 300° C. and 600° C.

15. The method of claim 11, wherein the binder is wholly or partially removed during annealing.

16. The method of claim 11, wherein the substrate is wholly or partially removed during annealing.

17. The method of claim 11, wherein the binder includes an inorganic polymer.

18. The method of claim 17, wherein the inorganic polymer includes a silicate, a phosphate, a borate, an aluminate, a sulfate, a nitride, or a combination thereof.

19. The method of claim 11, wherein the binder includes a soluble sodium silicate.

20. The method of claim 11, wherein the binder is applied as a polymer.

21. The method of claim 20, wherein the polymer is silicate glass.

22. The method of claim 11, wherein the binder is applied as a monomer.

23. The method of claim 22, wherein the monomer includes a phosphate.

24. The method of claim 11, wherein the binder is applied as a precursor.

25. The method of claim 24, wherein the precursor is tetraethyl orthosilicate (TEOS) or methyl orthosilicate (MEOS).

26. The method of claim 11, further adding an ion blocking layer.

27. The method of claim 11, further adding a current collector layer.

28. The method of claim 11, further adding an additive.

29. The method of claim 28, wherein the additive is an electrolyte precursor.

30. The method of claim 28, wherein the additive is an organic material.

31. The method of claim 28, further comprising heat treatment.

32. The method of claim 11, further comprising applying a packaging material.

33. The method of claim 32, wherein the packaging material includes a carbon layer.

34. The method of claim 32, wherein the packaging material includes a glass fiber or carbon fiber layer.

35. The method of claim 11, further comprising adding an electrolyte.
